(19) United States
(12) Patent Application Publication
(10) Pub. No.: US 2013/0280409 A1
(43) Pub. Date: Oct. 24, 2013

(54) Particles Having a High Load of Fragrance or Flavour Oil

(71) Applicant: Symrise AG, (US)

(72) Inventors: Steven Mushock, Highlands, NJ (US); Keith McDermott, Bound Brook, NJ (US); James G. Clothier, Ridgewood, NJ (US)

(21) Appl. No.: 13/849,009

(22) Filed: Mar. 22, 2013

Related U.S. Application Data
(63) Continuation-in-part of application No. 12/061,174, filed on Apr. 2, 2008, now abandoned.

(51) Int. Cl. A23L 1/221; C11B 9/00

(52) U.S. Cl. CPC A23L 1/221; C11B 9/00
USPC 426/651; 512/4

(57) ABSTRACT

Suggested is a particle containing a fragrance and/or flavour oil, the particle comprising:
(a) 50 to 80 wt. % fragrance and/or flavour oil,
(b) 5 to 25 wt. % octenylsuccinated starch,
(c) 5 to 25 wt. % of one or more mono alkaline metal phosphate salts,
(d) 0-10 wt. % of one or more additional ingredients,
   on condition that the amounts add to 100 wt. % and wherein the weight percent values are based on the total dry weight of the particle.

### FIELD OF THE INVENTION

The present invention relates to (preferably spray-dried) particles having a high load of fragrance (perfume) or flavour oil, a process for their preparation, its use for perfuming and/or flavoring products and products comprising such particles.

### BACKGROUND OF THE INVENTION

The perfuming or flavoring of products has been known for a long time. For perfuming or flavoring purposes either liquids or solids (i.e. fragrances or flavors applied to solid carriers, e.g. spray-dried, or enclosed in solid carriers) are conventionally used in this procedure.

U.S. Pat. No. 6,790,814 (P&G) teaches a three part core-shell system consisting of a core, an intermediate coating and an external coating. Phosphate is listed as one of several possible external coating components.

WO 1998 042818 A1 (P&G) describes a core particle with a porous carrier and a glassy encapsulating material surrounded by one or two additional coatings. Phosphate is listed as one of several possible additives to the external coating.

EP 1160311 B1 (P&G) discloses a glassy encapsulation material that can additionally contain porous additives and additional coatings around the core material. Phosphate is listed as one of several possible additives to the core material and coating.

Glassy particles are conventionally formed by dissolving the components into syrup, allowing it to cool below the glass transition temperature, then using mechanical means to break the glass into particles.

US 2004/0022821 (Holzer) solves the problem associated with the deflagration of perfume loaded particles by adding flame retardants, inter alia also inorganic phosphates. The document does not disclose modified starches as carriers and neither teaches nor suggests mixtures of octenylsuccinated starch and phosphate salts for improving the loading capacity of fragrance or flavour particles.

US 2006/0128586 (Lant) is directed to the controlled release of actives during the washing process. The document is silent with respect to inorganic phosphates as actives. Octenylsuccinated starch is cited as a preferred carrier, however not associated with the loading oft he particles, but for its generic ability to emulsify actives.

Encapsulation of fragrance or flavor oil by means of spray-drying, as described, for example, in U.S. Pat. No. 3,159,585, U.S. Pat. No. 3,971,852, U.S. Pat. No. 4,532,145 or U.S. Pat. No. 5,124,162, is well known in the art. The content of fragrance or flavor oil in known spray-dried particles comprising is conventionally achievable up to a content of 40-45 wt. % fragrance or flavor oil, based on the total weight of the particles.

The encapsulation of fragrances is well-known in the art. An antiperspirant/deodorant containing microcapsules is disclosed in U.S. Pat. No. 5,176,903 (Revlon) where a fragrance oil and ester are encapsulated by a food starch and polysaccharide composition.

Such particles can be used for perfuming or flavoring the following examples of consumer products, such as underarm deodorants and antiperspirants, solid sticks and aerosols, powdered laundry detergents, fragranced cat litter, and the like.

The consumer product market is a very competitive market, where the price of the product must also be competitive. Accordingly, it is desired to lower the production costs, in particular the raw material costs of the perfuming and flavoring particles used for perfuming or flavoring the perfumed or flavored products. One way to lower the raw material costs is to raise the content of the fragrance and/or flavor oil per particle so that the amount of the perfumed or flavored particles used to the perfumed or flavored consumer products can be reduced.

Further to this it is often desired to control, in particular to retard the release of the perfume or flavor out of the consumer products, in particular when the perfumed or flavored consumer products will be used in (cold) water. Moreover, it is desired that the fragrance or flavor oil containing particles as raw material can be easily prepared and are stable both mechanically and against oxidation.

Therefore, the problem underlying the present invention has been providing particles that overcome the disadvantages known from the state of the art described above. In particular, it has been the object of the invention to develop particles which are easy to prepare, showing simultaneously a high load of fragrance or flavour oil and an improved stability against mechanical forces and chemical degradation and oxidation.

### SUMMARY OF THE INVENTION

One or more of the main objects are solved by the subject matter of the independent claims. Preferred embodiments are set out in the dependent claims and are also disclosed in the detailed description hereinafter.

Therefore, a first embodiment of the present invention is directed to a particle containing a fragrance and/or flavour oil, the particle comprising:
(a) 50 to 80 wt. % fragrance and/or flavour oil,
(b) 5 to 25 wt. % octenylsuccinated starch,
(c) 5 to 25 wt. % of one or more mono alkaline metal phosphate salts,
(d) 0 to 10 wt. % of one or more additional ingredients,
   on condition that the amounts add to 100 wt. % and wherein the weight percent values are based on the total dry weight of the particle.

Unless stated otherwise, in the present description of inventive particles, weight percent values of constituents of the inventive particles are based on the total dry (i.e. water-free) weight of the inventive particles.

A second subject matter of the present invention relates to a process for producing the inventive fragrance and/or flavor oil containing particles comprising or consisting of the following steps:
(i) forming a mixture comprising the following constituents (a) through (e)
   (a) 20 to 56 wt. % fragrance and/or flavour oil,
   (b) 2 to 17.5 wt. % octenylsuccinated starch,
   (c) 2 to 17.5 wt. % of one or more mono alkaline metal phosphate salts,
   (d) 0 to 7 wt. % of one or more additional ingredients and
   (e) 30 to 60 wt. % of water,
   on condition that the amounts add to 100% b.w. and wherein the weight percent values are based on the total weight of the mixture and then
(ii) drying the mixture of step i) to produce the fragrance and/or flavour oil containing particles.

A third subject matter of the present invention relates to a fragrance and/or flavor containing particle obtainable by the inventive process of production as set out hereinbefore. A fourth subject matter of the present invention relates to a perfumed and/or flavored consumer product comprising one or more inventive fragrance and/or flavor oil containing particles.

A fifth subject matter of the present invention relates to a method of perfuming or flavoring a consumer product by adding one or more inventive fragrance and/or flavor oil containing particles to the consumer product.

A sixth subject matter of the present invention relates to a use of one or more of the inventive fragrance and/or flavor oil containing particles to perfume and/or flavor a consumer product.

All percentages, ratios and proportions herein are on a weight basis unless otherwise indicated. All documents cited herein are hereby incorporated by reference.

The subject matter of the present invention as set out hereinbefore can also comprises in any possible combination all preferred embodiments as set out in the dependent claims or disclosed in the following detailed description.

### DETAILED DESCRIPTION OF THE PRESENT INVENTION

The present invention relates to a fragrance and/or flavor oil containing particle comprising or consisting of
(a) 50 to 80 wt. %, preferably 55 to 78 wt. % fragrance and/or flavor oil,
(b) 5 to 25 wt. %, preferably 10 to 25 wt. % octenylsuccinated starch,
(c) 5 to 25 wt. % of one or more phosphate salts selected from mono alkaline metal phosphates, preferably 5 to 15 wt. % of monosodium and/or monopotassium phosphate and
(d) 0 to 10 wt. %, preferably O-5 wt. % of one or more additional ingredients,
   on condition that the amounts add to 100 wt. % and wherein the weight percent values are based on the total dry weight of the particle as well as perfumed and/or flavored consumer products comprising the inventive particles.

It was surprisingly found by the inventors that the inventive blend of the specific phosphates salts selected from mono alkaline metal phosphates according constituent (c) and the octenylsuccinated starch ingredient according to constituent (b) improves the emulsification capacity of the fragrance and/or flavor oil containing mixture and resulted in a fragrance and/or flavor oil loading of the modified starch far higher than the normal loading capacity, while at the same time improving mechanical and chemical stability of the particles.

Experiments encompassed different ratios of the constituents (a) through (c), namely the fragrance and/or flavor oil, the modified starch or the specific phosphates achieved
(i) a fragrance and/or flavor oil loading up to 80 wt. % based on the total dry weight of the inventive particles,
(ii) variable controlled release characteristics of the fragrance or flavor out of the inventive particles,
(iii) free flowing inventive particles,
(iv) a comparatively small particle size distribution of the inventive particles and
(v) a comparatively very low surface oil content based on the total weight of the inventive particles.

The high fragrance and/or flavor oil loading of up to 80 wt.-% allows for reducing the amount of the inventive particles when perfuming or flavoring consumer products and accordingly the costs, in particular the raw material costs can be lowered. The free flowability and the comparatively small particle size distribution of the inventive particles indicate that the particles can be handled easily when manufacturing consumer products. The comparatively low content of the surface oil indicates that the inventive particles are comparatively stable against oxidation as the content of surface oil directly correlates to the oxidation sensitivity. Accordingly, one or more of the main objects of the present invention are achieved by the inventive particles and, thus, the surprising characteristics of the inventive particles are all beneficial to the normal usage within consumer products containing microencapsulated fragrance or flavor oils.

The inventive fragrance and/or flavor oil containing particles are preferably formed by drying techniques, preferably the spray-drying technique. Accordingly, the process of producing the inventive particles comprises or consists of the following steps:
i. forming a mixture comprising or consisting of the following constituents (a) through (e)
   (a) 20 to 56 wt. %, preferably 27.5 to 52 wt. %, fragrance and/or flavor oil,
   (b) 2 to 17.5 wt. %, preferably 2.25 to 11.25 wt. %, octenylsuccinated starch,
   (c) 2 to 17.5 wt. %, preferably 2.25 to 11.25 wt. %, of one or more phosphate salts selected from mono alkaline metal phosphates,
   (d) 0 to 7 wt. %, preferably 0 to 6.5 wt. %, of one or more additional ingredients and
   (e) 30 to 60 wt %., preferably 35 to 55 wt. %, of water,
   in each case based on the total weight of the mixture and then
ii. drying, preferably spray-drying, the mixture of step i) to result in the fragrance and/or flavor oil containing particles.

The mixture of step i) usually is an emulsion containing the octenylsuccinated starch, one or more of the phosphate salts, the fragrance and/or flavor oil and the water.

For producing the fragrance and/or flavor oil containing particles according to the present invention various known drying techniques or processes can be employed. The spray-drying technique preferably used herein to produce the preferred particles according to the present invention aerosolizes droplets of said mixture (usually an emulsion) in a heated environment which allows most of the water to evaporate, resulting in a virtually homogenous particle.

In the inventive spray-drying process, particles usually are produced by a three step operation comprising
(1) forming an emulsion of the liquid core material in a solution, usually aqueous, of the normally solid coating material and
(2) breaking up the emulsion into droplets of desired size, e.g., in a spray nozzle, from a spinning disc, or apertured centrifugal atomizer, and
(3) removing moisture in a drying environment to solidify the coating material in the droplets to form solid particles.

The drying environment preferably is hot drying air, e.g., in a spray-drying tower. The particles produced by this process which may be “hollow” or “solid”, are characterized by cellular structure comprising many dispersed globules of the core material in a matrix of the coating material. “Solid” in this context means that a particle has more or less uniform structure throughout, as opposed to the “hollow” form of particle which has a shell surrounding a void, but it does not imply absence of pores or cells in the body thereof.

One of the preferred processes for producing particles according to the present invention involves spraying the mixture of step i) of the inventive production process into a drying atmosphere to form globules or droplets. The products of this inventive process are dry, somewhat porous powders containing roughly spherical, convoluted particles with the coating material in the solid state and with the fragrance or flavor oil either dispersed as minute droplets throughout the particle, or dissolved in a solid matrix, or both, depending on the compatibility of the oil and coating material comprising modified starch, and one or more mono alkaline metal phosphates.

In a further embodiment the inventive fragrance and/or flavor oil containing particles can be produced by continuous fluidized bed spray granulation, for example according to EP 0163836 A1 or WO 00/36931, incorporated herein in their entirety.

The inventive fragrance and/or flavor oil containing particles in particular produced by continuous fluidized bed spray granulation are free flowing, have low dust generation, and are granular particles.

In accordance with the present invention the spray mixture of step i) of the inventive production process can be sprayed from below, from the side, or even from above into the fluidized bed.

Discontinuous fluidized bed spray granulation, for example according to EP-A 70 719 incorporated herein in its entirety, is feasible, but not preferred.

From the spray mixture of step i) of the inventive production process, the inventive particles are produced preferably with a particle size (particle diameter) of equal to or less than 300 micrometer (microns, .mu.m). In a more preferred embodiment the inventive (preferably spray-dried) fragrance and/or flavor oil containing particles have an average particle size (median value) in the range of 5 to 125 microns, more preferably in the range of 5 to 80 microns, and most preferably in the range of 10 to 50 microns. The advantage of smaller differences in the size distribution of the inventive fragrance and/or flavor oil containing particles is that the inventive particles are less de-mixed in a further manufacturing step and have similar, comparatively uniform release properties regarding the fragrance and/or flavor oil.

In a preferred embodiment of the invention the particle size determination is conducted by laser diffraction (for example with the Beckman Coulter LS Particle Size Analyzer or the Master Sizer® MSS Longbench by Malvern Instruments Ltd.).

In a still further preferred embodiment the inventive (preferably spray-dried) fragrance and/or flavor oil containing particles have a residual water content of equal to or less than 3 wt. %, preferably the residual water content in the range of 0.1 to 2.5 wt. %, more preferably in the range of 0.3 to 2 wt. %, based on the total weight of the particle. The advantage correlated with a low water content relate to the fact that the inventive particles are less exposed to microorganism growth and, thus, the amount of preservatives in the inventive particles can be reduced.

In a still further preferred embodiment the inventive (preferably spray-dried) fragrance and/or flavor oil containing particles have an amount of surface oil of equal to or less than 4 wt. %, more preferably of less than 3 wt. %, most preferably of less than 2.5 wt. %, based on the total dry weight of the particle.

Accordingly, in a still further preferred embodiment the inventive (spray-dried) fragrance and/or flavor oil containing particles comprise or consist of:
(a) 55 to 78 wt. % fragrance and/or flavor oil,
(b) 10 to 25 wt. % octenylsuccinated starch,
(c) 5 to 15 wt. % of monosodium and/or monopotassium phosphate and
(d) 0 to 5 wt. % of one or more additional ingredients,
   on condition that the amounts add ro 100 wt. % and wherein the weight percent values are based on the total dry weight of the particle.

In a still more preferred embodiment the inventive (spray-dried) fragrance and/or flavor oil containing particles comprise or consist of:
(a) 60 to 75 wt. % fragrance or flavor oil,
(b) 15 to 22 wt. % of octenylsuccinated starch,
(c) 8 to 12 wt. % of monosodium phosphate;
(d) 0 to 5 wt. % additional ingredients.

In a still more preferred embodiment the inventive (spray-dried) fragrance and/or flavor oil containing have (in addition)
(i) an average particle size in the range of 5 to 125 microns, and/or
(ii) a residual water content in the range of 0.1 to 2.5 wt. %, and/or
(iii) an amount of surface oil of less than 3 wt. %, wherein all weight percent values are based on the total dry weight of the particles.

The preferred embodiments of the inventive fragrance and/or flavor oil containing particles and the inventive production process thereof can be combined in every possible way with each other and with the preferred embodiments of the invention as further set out hereinbelow. In the following the preferred embodiments of constituents (a) through (d) of the inventive fragrance (perfume) and/or flavor oil containing particles are further disclosed:

### Constituent (a)

A fragrance (perfume) or flavor oil in the context of the present invention comprises at least one volatile fragrance and/or flavor substance (i.e. sensory active substance), but usually two or more different volatile fragrance and/or flavor substances. Fragrance or flavor oils typically are complex mixtures of volatile components. In particular, fragrance or flavor substances in the context of the present invention are sensorially active substances having a vapor pressure of at least 0.01 Pa at 25° C., more preferably a vapor pressure of at least 0.025 Pa at 25° C. Fragrance or flavor substances in large part show a vapor pressure of at least 0.5 Pa at 25° C., therefore such fragrance or flavor substances in particular are meant by the term volatile component.

The fragrance or flavor oil loading is in the range of 50 to 80 wt. %, preferably in the range of 55 to 78 wt. %, more preferably in the range of 60 to 75 wt. %, most preferably in the range of 65 to 75 wt. %, based on the total dry weight of the (preferably spray-dried) particle.

Preferably, the weight percent value of fragrance or flavor oil means the total weight percent value of volatile fragrance or flavor substances based on the total dry weight of the inventive particles.

Preferred volatile fragrance substances as part of the fragrance oil are:

Extracts of natural raw materials such as essential oils, concretes, absolutes, resins, resinoids, balsams, tinctures such as for example ambergris tincture; amyris oil; angelica seed oil; angelica root oil; aniseed oil; valerian oil; basil oil; wood moss absolute; bay oil; mugwort oil; benzoin resin; bergamot oil; beeswax absolute; birch tar oil; bitter almond oil; savory oil; bucco-leaf oil; cabreuva oil; cade oil; calamus oil; camphor oil; cananga oil; cardamom oil; cascarilla oil; cassia oil; cassia absolute; castoreum absolute; cedar-leaf oil; cedarwood oil; cistus oil; citronella oil; lemon oil; copaiba balsam; copaiba balsam oil; coriander oil; costus root oil; cumin oil; cypress oil; davana oil; dill oil; dillseed oil; eau de brouts absolute; oakmoss absolute; elemi oil; tarragon oil; eucalyptus citriodora oil; eucalyptus oil; fennel oil; fir oil; galbanum oil; galbanum resin; geranium oil; grapefruit oil; guaiac wood oil; gurjun balsam; gurjun balsam oil; helichrysum absolute; helichrysum oil; ginger oil; iris root abolute; iris root oil; jasmine absolute; calamus oil; blue camomile oil; Roman camomile oil; carrot-seed oil; cascarilla oil; pine-needle oil; spearmint oil; caraway oil; labdanum oil; labdanum absolute; labdanum resin; lavandin absolute; lavandin oil; lavender absolute; lavender oil; lemongrass oil; lovage oil; distilled lime oil; pressed lime oil; linaloe oil; litsea cubeba oil; bay-leaf oil; mace oil; marjoram oil; mandarin oil; massoi bark oil; mimosa absolute; ambrette oil; tincture of musk; clary sage oil; myristica oil; myrrh absolute; myrrh oil; myrtle oil; clove leaf oil; clove flower oil; neroli oil; olibanum abolute; olibanum oil; opopanax oil; orange blossom absolute; orange oil; origanum oil; palmarosa oil; patchouli oil; perilla oil; Peru balsam oil; parsley leaf oil; parsley seed oil; petitgrain oil; peppermint oil; pepper oil; pimento oil; pine oil; pennyroyal oil; rose absolute; rosewood oil; rose oil; rosemary oil; Dalmatian sage oil; Spanish sage oil; sandalwood oil; celery seed oil; spike lavender oil; Japanese aniseed oil; styrax oil; tagetes oil; fir-needle oil; tea-tree oil; turpentine oil; thyme oil; Tolu balsam; tonka absolute; tuberose absolute; vanilla extract; violet leaf absolute; verbena oil; vetiver oil; juniper oil; wine-lees oil; wormwood oil; wintergreen oil; ylang oil; hyssop oil; civet absolute; cinnamon leaf oil; cinnamon bark oil; as well as fractions thereof or constituents isolated therefrom;

Individual volatile fragrance substances are preferably selected from the group consisting of:
Hydrocarbons, preferably 3-carene; α-pinene; β-pinene; α-terpinene; γ-terpinene; p-cymene; bisabolene; camphene; caryophyllene, cedrene; farnesene; liminene; longifolene; myrcene; ocimene; valencene; (E,Z)-1,3,5-undecatriene;
Aliphatic alcohols, preferably hexanol; octanol; 3-octanol; 2,6-dimethylheptanol; 2-methylheptanol; 2-methyloctanol; (E)-3-hexenol; (E) and (Z)-3-hexenol; 1-octen-3-ol; mixtures of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol;
Alphatic aldehydes and their acetals, preferably hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-5,9-undecadienal; heptanal diethyl acetal; 1,1-dimethoxy-2,2,5-trimethyl-4-hexene; citronellyl oxyacetaldehyde;
Aliphatic ketones and oximes thereof, preferably 2-heptanone; 2-octanone; 3-octanone; 2-nonanone; 5-methyl-3-heptanone; 5-methyl-3-heptanone oxime; 2,4,4,7-tetramethyl-6-octen-3-one;
Aliphatic sulphur-containing compounds, preferably 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol;
Aliphatic nitriles, preferably 2-nonenenitrile; 2-tridecenenenitrile; 2,12-tridecenene-nitrile; 3,7-dimethyl-2,6-octadienenitrile; 3,7-dimethyl-6-octenenitrile;
Aliphatic carboxylic acids and esters thereof, preferably (E)- and (Z)-3-hexenyl formate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexyl butyrate; (E)- and (Z)-3-hexenyl isobutyrate; hexyl crotonate; ethyl isovalerate; ethyl 2-methylpentanoate; ethyl hexanoate; allyl hexanoate; ethyl heptanoate; allyl heptanoate; ethyl octanoate; ethyl (E,Z)-2,4-decadienoate; methyl 2-octynoate; methyl 2-nonynoate; allyl-2-isoamyloxyacetate; methyl-3,7-dimethyl-2,6-octadienoate;
Acyclic terpene alcohols, preferably citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and formates, acetates, propionates, isobutyrates, butyrates, isovalerates, pentanoates, hexanoates, crotonates, tiglinates, 3-methyl-2-butenoates thereof;
Acyclic terpene aldehydes and ketones, preferably geranial; neral; citronellal; 7-hydroxy-3,7-dimethyloctanal; 7-methoxy-3,7-dimethyloctanal; 2,6,10-trimethyl-9-undecenal; geranylacetone; and the dimethyl and diethyl acetals of geranial, neral, 7-hydroxy-3,7-dimethyloctanal;
Cyclic terpene alcohols, preferably menthol; isopulegol; alpha-terpineol; terpineol-4; menthan-8-ol; menthan-1-ol; menthan-7-ol; borneol; isoborneol; linalool oxide; nopol; cedrol; ambrinol; vetiverol; guaiol; and the formates, acetates, propionates, isobutyrates, butyrates, isovalerates, pentanoates, hexanoates, crotonates, tiglinates, 3-methyl-2-butenoates thereof;
Cyclic terpene aldehydes and ketones, preferably menthone; isomenthone; 8-mercaptomenthan-3-one; carvone; camphor; fenchone; alpha-ionone; beta-ionone; alphan-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; nootkatone; dihydronootkatone; alpha-sinensal; beta-sinensal; acetylated cedarwood oil (methyl cedryl ketone);
Cyclic alcohols, preferably 4-tert.-butylcyclohexanol; 3,3,5-trimethylcyclohexanol; 3-isocamphylcyclohexanol; 2,6,9-trimethyl-Z2,Z5,E9-cyclododecatrien-1-ol; 2-isobutyl-4-methyltetrahydro-2H-pyran-4-ol;
Cycloaliphatic alcohols, preferably alpha-3,3-trimethylcyclohexylmethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol;
Cyclic and cycloaliphatic ethers, preferably cineol; cedryl methyl ether; cyclododecyl methyl ether; (ethoxymethoxy)cyclododecane; alpha-cedrene epoxide; 3a,6,6,9a-tetramethyldodecahydronaphtho[2,1-b]furan; 3a-ethyl-6,6,9a-trimethyldodecahydro-naphtho[2,1-b]furan; 1,5,9-trimethyl-13-oxabicyclo[10.1.0]trideca-4,8-diene; rose oxide; 2-(2,4-dimethyl-3-cyclohexen-1-yl)-5-methyl-5-(1-methylpropyl)-1,3-dioxane;
Cyclic ketones, preferably 4-tert.-butylcyclohexanone; 2,2,5-trimethyl-5-pentylcyclopentanone; 2-heptylcyclopentanone; 2-pentylcyclopentanone; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert.-pentylcyclohexanone; 5-cyclohexadecen-1-one; 6,7-dihydro-1,1,2,3,3-pentamethyl-4(5H)-indanone; 9-cycloheptadecen-1-one; cyclopentadecanone; cyclohexadecanone;
Cycloaliphatic aldehydes, preferably 2,4-dimethyl-3-cyclohexenecarbaldehyde; 2-methyl-4-(2,2,6-trimethyl-cyclohexen-1-yl)-2-butenal; 4-(4-hydroxy-4-methylpentyl)-3-cyclohexenecarbaldehyde; 4-(4-methyl-3-penten-1-yl)-3-cyclohexenecarbaldehyde;
Cycloaliphatic ketones, preferably 1-(3,3-dimethylcyclohexyl)-4-penten-1-one; 1-(5,5-dimethyl-1-cyclohexen-1-yl)-4-penten-1-one; 2,3,8,8-tetramethyl-1,2,3,4,5,6,7,8-octahydro-2-naphthalenyl methyl ketone; methyl-2,6,10-trimethyl-2,5,9-cyclododecatrienyl ketone; tert.-butyl (2,4-dimethyl-3-cyclohexen-1-yl)ketone;
Esters of cyclic alcohols, preferably 2-tert.-butylcyclohexyl acetate; 4-tert.-butyl-cyclohexyl acetate; 2-tert.-pentylcyclohexyl acetate; 4-tert.-pentylcyclohexyl acetate; decahydro-2-naphthyl acetate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6-indenyl propionate; 4,7-methano-3a,4,5,6,7,7a-hexahydro-5 or 6-indenyl isobutyrate; 4,7-methanooctahydro-5 or 6-indenyl acetate;
Esters of cycloaliphatic carboxylic acids, preferably allyl 3-cyclohexylpropionate; allyl cyclohexyloxyacetate; methyl dihydrojasmonate; methyl jasmonate; methyl 2-hexyl-3-oxocyclopentanecarboxylate; ethyl 2-ethyl-6,6-dimethyl-2-cyclohexenecarboxylate; ethyl 2,3,6,6-tetramethyl-2-cyclohexenecarboxylate; ethyl 2-methyl-1,3-dioxolane-2-acetate;
Aromatic hydrocarbons, preferably styrene and diphenylmethane;
Araliphatic alcohols, preferably benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;
Esters of araliphatic alcohols and aliphatic carboxylic acids, preferably benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate; araliphatic ethers such as for example 2-phenylethyl methyl ether; 2-phenylethyl isoamyl ether; 2-phenylethyl 1-ethoxyethyl ether; phenylacetaldehyde dimethyl acetal; phenylacetaldehyde diethyl acetal; hydratropaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;
Aromatic and araliphatic aldehydes, preferably benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert.-butylphenyl)propanal; 3-(4-tert.-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylenedioxybenzaldehyde; 3,4-dimethoxybenzaldehyde; 2-methyl-3-(4-methoxyphenyl)propanal; 2-methyl-3-(4-methylenedioxyphenyl)propanal;
Aromatic and araliphatic ketones, preferably acetophenone; 4-methylacetophenone; 4-methoxyacetophenone; 4-tert.-butyl-2,6-dimethylacetophenone; 4-phenyl-2-butanone; 4-(4-hydroxyphenyl)-2-butanone; 1-(2-naphthalenyl)ethanone; benzophenone; 1,1,2,3,3,6-hexamethyl-5-indanyl methyl ketone; 6-tert.-butyl-1,1-dimethyl-4-indanyl methyl ketone; 1-[2,3-dihydro-1,1,2,6-tetramethyl-3-(1-methylethyl)-1H-5-indenyl]ethanone; 5′,6′,7′,8′-tetrahydro-3′,5′,5′,6′,8′,8′-hexamethyl-2-acetonaphthone;
Aromatic and araliphatic carboxylic acids and esters thereof, preferably acid; phenylacetic acid; methyl benzoate; ethyl benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl 2,4-dihydroxy-3,6-dimethylbenzoate; ethyl 3-phenylglycidate; ethyl 3-methyl-3-phenylglycidate;
Nitrogen-containing aromatic compounds, preferably 2,4,6-trinitro-1,3-dimethyl-5-tert.-butylbenzene; 3,5-dinitro-2,6-dimethyl-4-tert.-butylacetophenone; cinnamonitrile; 5-phenyl-3-methyl-2-pentenenitrile; 5-phenyl-3-methylpentanenitrile; methyl anthranilate; methyl N-methylanthranilate; Schiff bases of methyl anthranilate with 7-hydroxy-3,7-dimethyloctanal; 2-methyl-3-(4-tert.-butylphenyl)propanal or 2,4-dimethyl-3-cyclohexenecarbaldehyde; 6-isopropylquinoline; 6-isobutylquinoline; 6-sec.-butylquinoline; indole; skatole; 2-methoxy-3-isopropylpyrazine; 2-isobutyl-3-methoxypyrazine;
Phenols, phenyl ethers and phenyl esters, preferably estragole; anethole; eugenol; eugenyl methyl ether; isoeugenol; isoeugenyl methyl ether; thymol; carvacrol; diphenyl ether; betanaphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate;
Heterocyclic compounds, preferably 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;
Lactones, preferably 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 1,15-pentadecanolide; cis and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene 1,12-dodecanedioate; ethylene 1,13-tridecanedioate; coumarin; 2,3-dihydrocoumarin; α-tahydrocoumarin.

Fragrance oils used in the context of the present invention may contain one or more of the following solvents/diluents: ethanol, isopropanol, diethylene glycol monoethyl ether, glycerol, propylene glycol, 1,2-butylene glycol, dipropylene glycol, diethyl phthalate, triethyl citrate, isopropyl myristate and the like. These solvents/diluents are then considered as being comprised in constituent (a).

Flavor oils used in the context of the present invention may contain the following solvents/diluents: ethanol, vegetable oil triglycerides, 1,2-propylene glycol, benzyl alcohol, triacetin (glycerol triacetate), diacetin (glycerol diacetate), triethyl citrate, glycerol. These solvents/diluents are then considered as being comprised in constituent (a).

Preferred flavor oils are, for example, essential oils, fractions thereof, or individual aroma substances. Examples which may be mentioned are: extracts from natural raw materials, such as essential oils, concretes, absolutes, resins, resinoids, balsams and tinctures, such as aniseed oil; basil oil; bergamot oil; bitter almond oil; camphor oil; lemon oil; eucalyptus oil; geranium oil; grapefruit oil; ginger oil; camomile oil; spearmint oil, caraway oil, lime oil; mandarin oil; clove (blossom) oil, orange oil; peppermint oil; rose oil; rosemary oil; sage oil; yarrow oil; star aniseed oil; thyme oil; vanilla extract; juniper berry oil; wintergreen oil; cinnamon leaf oil; cinnamon bark oil; and fractions thereof and constituents isolated therefrom.

Individual volatile flavor substances, particularly useful in oral care compositions, are preferably selected from the group consisting of anethol, menthol, l-menthol, menthone, isomenthone, menthyl acetate, menthofuran, menthyl methylether, mintlactone, eucalyptol, limonene, eugenol, alpha-pinene, beta-pinene, cis-sabinene hydrate, 3-octanol, l-carvone, gammaoctalactone, gamma-nonalactone, germacrene-D, viridiflorol, 1,3E,5Z-undecatriene, isopulegol, piperitone, 2-butanone, ethyl formiate, 3-octyl acetate, isoamyl isovalerianate, hexanol, hexanal, cis-3-hexenol, linalool, alpha-terpineol, cis-/trans-carvyl acetate, p-cymol, thymol, 4,8-dimethyl-3,7-nonadien-2-one, damascenone, damascone, rose oxide, dimethyl sulfide, fenchol, acetaldehyde diethylacetal, cis-4-heptenal, isobutyraldehyde, isovaleraldehyde, cis-jasmone, anisaldehyde, methyl salicylate, myrtenyl acetate, 8-ocimenyl acetate, 2-phenylethyl alcohol, 2-phenylethyl isobutyrate, 2-phenylethyl isovalerate, cinnamic aldehyde, geraniol and nerol.

The preferred embodiments of the fragrance and flavor oil of constituent (a) can be combined in any possible way with each other and/or with any of the (preferred) embodiments of the constituents (b) through (d) of the inventive fragrance and/or flavor oil containing particles as well as with the further subject matter of the present invention including the respective preferred embodiments thereof.

### Constituent (b)

The octenylsuccinated starch (CAS-number 125109-81-1, chemical name: amylopectin, hydrogen 1-octadecenylbutanedioate; E1450), is e.g., commercially available as Hi-Cap 100 from National Starch). With octenylsuccinated starch the highest levels of loading of fragrance or flavor oil in the particles according to the present invention is achievable, said particles at the same time having a very low amount of surface oil and/or a very low residual water content.

The total amount of octenylsuccinated starch as constituent (b) is in the range of 5 to 25 wt. %, preferably in the range of 10 to 25 wt. %, more preferably in the range of 15 to 22 wt. %, based on the total dry weight of the (preferably spray-dried) particle.

### Constituent (c)

Constituent (c) is the mono alkaline metal phosphate salt corresponding to the formula MH₂PO₄, M being an alkaline metal. Preferably constituent (c) is a phosphate salt selected from monosodium phosphate NaH₂PO₄ and/or monopotassium phosphate KH₂PO₄. Preferred is monosodium phosphate.

The total amount of phosphate salts of constituent (c) is in the range of 5 to 25 wt. %, preferably in the range of 5 to 15 wt. %, more preferably in the range of 8 to 12 wt. %, based on the total dry weight of the (preferably spray-dried) particle.

When the (spray-) dried particles contain noticeably less than 5 wt. % of phosphate salts (in particular less than 4 wt. %), these particles were found not to be free-flowing.

The weight ratio of constituent (b): constituent (c) preferably lies in the range of 4:1-1:3, more preferably in the range of 3:2-1:2, most preferably in the range of 2:1-1:1.

The preferred embodiments of constituent (c) can be combined in any possible way with each other and/or with any of the (preferred) embodiments of the constituents (a), (b) and (d) of the inventive fragrance and/or flavor oil containing particles as well as with the further subject matter of the present invention including the respective preferred embodiments thereof.

### Optional Additional Constituents (d)

In a preferred embodiment the total amount of optional additional constituents (d) is preferably in the range of 0-5 wt. %.

In a further preferred embodiment the optional ingredients and additives according to constituent (d) of the inventive fragrance and/or flavor oil containing particles are, e.g., selected from the following group:

preservatives, abrasives, anti-acne agents, anti-skin ageing agents, antibacterial agents, anticellulite agents, anti-dandruff agents, anti-inflammatory agents, irritation-preventing or inhibiting agents, antimicrobial agents, antioxidants, astringents, antiperspirants, antiseptics, antistatics, binders, buffers, carriers, chelating agents, cell stimulants, cleaning agents, caring agents, depilatories, surface-active agents, deodorants, antiperspirants, softeners, emulsifiers, enzymes, essential oils, fibres, film-formers, fixatives, flow-agents (anti-caking agents), foaming agents, foam stabilisers, foam-suppressors, foam boosters, fungicides, gelling agents, gel-forming agents, hair-care agents, hair-shaping agents, hair-straightening agents, moisturizing agents, wetting agents, humectants, bleaching agents, starching agents, stain-removing agents, optical brighteners, water-proofing agents, soil-repelling agents, friction-reducing agents, lubricants, moisture creams, ointments, clouding agents, plasticizers, opacifiers, polishes, glossing agents, polymers, powders, proteins, refatting agents, exfoliating agents, silicones, skin-soothing agents, skin-cleansing agents, skin-care agents, skin-healing agents, skin-lightening agents, skin-protecting agents, skin softening agents, cooling agents, skin-cooling agents, heating agents, skin-heating agents, stabilisers, UV-absorbing agents, UV-filters, laundry detergents, fabric softeners, suspending agents, skin-tanning agents, thickeners, vitamins, minerals, oils, waxes, fats, phospholipids, saturated fatty acids, monounsaturated or polyunsaturated fatty acids, ahydroxy acids, polyhydroxy fatty acids, dyes, coloring agents, color-protection agents, pigments, anti-corrosives, sweeteners, food acids, polyols, surfactants, electrolytes, organic solvents or silicone derivatives.

### 1.1 Preservatives

In a still further preferred embodiment one or more of the following preservatives are comprised in constituent (d) in the inventive fragrance and/or flavor oil particles: sodium chloride, sucrose, nitrites, preferably Na, K and/or Ca nitrites and sulfites, more preferably Na, K and/or Ca sulfites; organic acids or salts thereof, preferably sorbic acid, benzoic acid, formic acid and the Na, K and Ca salts of these acids, as well as 4-hydroxybenzoic acid esters, salicylic acid and dehydracetic acid. The total amount of the one or more preservatives as set out hereinbefore is preferably effective to preserve the inventive fragrance and/or flavor oil particles.

Still further preferred are one or more preservative acids selected from the group consisting of: citric acid, adipic acid, malic acid, fumaric acid, ascorbic acid (vitamin C), succinic acid and tartaric acid, more preferred are citric acid, ascorbic acid and malic acid.

### 1.2 Cooling Agents

In a further preferred embodiment one or more cooling agents are comprised in constituent (d) of the particles according to the present invention and are preferably selected from the group consisting of: menthone glycerine acetal, menthyl lactate, more preferably I-menthyl I-lactate, substituted menthyl-3-carboxylic acid amides (e.g. menthyl-3-carboxylic acid-N-ethylamide, WS-3), 2-isopropyl-N-2,3-trimethyl butanamide (WS-23), substituted cyclohexane carboxylic acid amides, 3-menthoxypropane-1,2-diol, 2-hydroxyethyl menthyl carbonate, 2-hydroxypropyl menthyl carbonate, N-[[5-methyl-2-(1-methylethyl)cyclohexyl]-carbonyl]glycine ethyl ester (WS-5), isopulegol, menthyl hydroxycarboxylic acid esters (e.g. menthyl-3-hydroxybutyrate), monomenthyl succinate, 2-mercaptocyclodecanone, menthyl-2-pyrrolidin-5-one carboxylate, 2,3-dihydroxy-p-menthane, 3,3,5-trimethyl cyclohexanone glycerine ketal, 3-menthyl-3,6-di- and trioxaalkanoates, 3-menthyl methoxyacetate, and icilin.

### 1.3 Antioxidants

In a still further preferred embodiment one or more antioxidants, or substances which can intensify an antioxidative action, are suitable to be comprised in constituent (d) of the particles according to the invention and are preferably selected from the group consisting of: naturally occurring tocopherols and derivatives thereof, tocotrienols, flavonoids, ascorbic acid and its salts, alpha-hydroxy acids (e.g. citric acid, lactic acid, malic acid, tartaric acid) and Na, K and Ca salts thereof, constituents, extracts and fractions thereof isolated from plants, e.g. from tea, green tea, algae, grape seeds, wheat germ, rosemary and oregano; flavonoids, quercetin and phenolic benzylamines. Propyl gallate, octyl gallate, dodecyl gallate, butylhydroxyanisole (BHA), butylhydroxytoluene (BHT), lecithins, mono- and diglycerides of edible fatty acids esterified with citric acid, orthophosphates and Na, K and Ca salts of monophosphoric acid and ascorbyl palmitate are furthermore suitable as antioxidants.

### 1.4 Anti-Caking Agents

In a still further preferred embodiment one or more flow-agents (anti-caking agent), such as silica (SiO₂), are comprised in constituent (d) to additionally improve the already good flowing properties and/or to additionally avoid caking or agglomeration of the particles of the present invention.

### 1.5 Sugar Alcohols and Sweeteners

In a still further preferred embodiment one or more sugar alcohols are comprised in constituent (d) of the inventive particles and are preferably selected from the group consisting of: erythritol, threitol, arabitol, ribitol, xylitol, sorbitol, mannitol, dulcitol and lactitol. In a more preferred embodiment mannitol is comprised in constituent (d).

In a still further preferred embodiment one or more sweeteners are comprised in constituent (d) of the inventive particles and are preferably selected from the group consisting of: saccharin (optionally as the Na, K or Ca salt), aspartame (e.g. NutraSweet), cyclamate (optionally as the Na or Ca salt), acesulfame K (e.g. Sunett®), thaumatin and/or neohesperidin Dihydrochalcone. It is of course also possible to use alternatively or in addition one or more other preferred sweeteners selected from the group consisting of: stevioside, rebaudioside A, glycyrrhizin, ultrasweet, osladin, brazzein, miraculin, pentadin, phyllodulcin, dihydrochalcones, arylureas, trisubstituted guanidines, glycyrrhizin, superaspartame, sucralose (trichlorogalactosucrose, TGS), alitame, monellin or Neotame®.

### 1.6 Dyestuffs

In a still further preferred embodiment one or more substances of the group of dyestuffs, coloring agents and/or pigments are comprised in constituent (d). In the group of coloring agents the water-soluble coloring agents are preferred and most preferably one or more water-soluble coloring agents are selected from the group consisting of:

Tartrazine (E 102), Sunset Yellow (E 110), Carmoisine (E 122), Ponceau 4R (E 124), Amaranth (E 123), Allura Red (E 129), Brilliant Blue FCF (E 133), Indigo Carmine (E 132), Erythrosine (E 127), Black PN (E 151), Chocolate Brown HT (E155), Patent Blue V (E 131), Quinoline Yellow (E 104) and Green S (E 142);

FD&C Water Soluble Dyes: FD&C Blue No. 2, FD&C Blue No. 1, FD&C Green No. 3, FD&C Red No. 3,. FD&C Red No. 40, FD&C Yellow No. 6, FD&C Yellow No. 5, FD&C Red No. 4;

D&C Water Soluble: D&C Green 5, D&C Green 6, D&C Green 8, D&C Orange 4, D&C Red 17, D&C Red 28, D&C Red 33, D&C Red 34, D&C Red 36, D&C Red 6, D&C Red 7, D&C Red 8, D&C Yellow 10, D&C Yellow 11, D&C Yellow 8.

The preferred embodiments of constituent (d) can be combined in any possible way with each other and/or with any of the (preferred) embodiments of the constituents (a), (b) and (c) of the inventive fragrance and/or flavor oil containing particles as well as with the further subject matter of the present invention including the respective preferred embodiments thereof.

### Consumer Products

In accordance with the fourth subject matter of the present invention the inventive fragrance and/or flavor oil containing particles are comprised in perfumed and/or flavored consumer products. In the following the preferred embodiments of consumer products are disclosed:

In a preferred embodiment the inventive perfumed consumer products comprise one or more inventive fragrance oil containing particles and are preferably selected from the group consisting of: shaving lotions, pre-shave products, splash colognes and perfumed wipes, as well as for fragrancing acidic, alkaline or neutral cleaning products such as for example floor cleaners, window cleaners, dishwashing detergents, bath cleaners and sanitizers, abrasive creams, solid and liquid toilet cleaners, powdered and mousse carpet cleaners, liquid detergents, powder detergents, laundry pre-treatment products such as bleaches, soaking products and stain removers, fabric conditioners, laundry soaps, laundry tablets, disinfectants, hard surface disinfectants as well as air improvers in liquid or gel form or applied to a solid carrier, aerosol sprays, waxes and polishes such as furniture polishes, floor waxes, shoe creams as well as toiletries such as for example solid and liquid soaps, shower gels, shampoos, shaving soaps, shaving foams, bath oils, cosmetic emulsions of the oil-in-water, water-in-oil, and water-in-oil-in-water type, such as for example skin creams and lotions, face creams and lotions, sun-protection creams and lotions, after-sum creams and lotions, hand creams and lotions, foot creams and lotions, depilatory creams and lotions, after-shave creams and lotions, tanning creams and lotions, hair-care products such as for example hairsprays, hair gels, hair lotions, hair conditioners, permanent and semi-permanent hair dyes, hair-shaping products such as cold waving and hair-straightening products, hair tonics, hair creams and lotions, deodorants and antiperspirants such as for example underarm sprays, roll-ons, stick deodorants, cream deodorants, or decorative cosmetic products, candles and insect repellents.

Still further preferred inventive perfumed products are selected from the group consisting of:
cleaning products: dishwashing detergents, bath and sanitary cleaners, scouring milk, solid WC cleaners, powder and foam carpet cleaners, powdered laundry detergents, fabric softeners (see U.S. Pat. No. 5,500,138, incorporated herein by reference) fabric softener sheets, laundry pretreatment agents, bleaches, soaking agents, stain removers, washing soaps, washing tablets, disinfectants, surface disinfectants;
air freshening products: air fresheners in gel form, air fresheners in solid carrier, aerosol sprays;
waxes and polishes: furniture polishes, floor waxes, shoe creams;
bodycare compositions: solid soaps, shower gels, shampoos, shaving foams, cosmetic emulsions of the oil-in-water, water-in-oil and water-in-oil-in-water type, such as, for example, skin creams and lotions, face creams and lotions, sunscreen creams and lotions, aftersun creams and lotions, hand creams and lotions, foot creams and lotions, depilatory creams and lotions, tanning creams and lotions;
haircare products: hairsprays, hair gels, hairsetting lotions, permanent and semipermanent hair colorants, hair-shaping compositions;
deodorants and antiperspirants: underarm sprays, roll-ons, deodorant sticks, deodorant creams; and
decorative cosmetics: powdered make-up, foundations, lipsticks, mascara.

Preferred inventive perfumed products are low-moisture or dry products, i.e. products having a total water content of less than 25%, more preferred of less than 15%, even more preferred of less than 10%, based on the total weight of the product.

If the free water content of a product is comparatively high, the particles of the present invention can dissolve in the product during storage of the product and decrease in performance. Therefore, in a preferred embodiment, the inventive perfumed products have a free water content of less than 5%, based on the total weight of the product.

Still more preferred inventive perfumed products are selected from the group consisting of: underarm deodorants and antiperspirants, solid sticks and aerosols, powdered laundry detergents, powdered carpet deodorizers, cat litter, adult incontinence diapers, baby diapers, bath salts and body talc.

Most preferred inventive perfumed products are selected from the group consisting of: underarm deodorants and antiperspirants, solid sticks and aerosols, fabric softener sheets and powdered laundry detergents.

Regarding typical ingredients, actives and their respective amounts in preferred compositions see U.S. Pat. No. 6,123,932 for underarm deodorants, U.S. Pat. No. 5,348,667 for fabric softener sheets and U.S. Pat. No. 6,491,728 for powdered laundry detergents, all of said patents being incorporated herein in their entirety.

### Primary Ingredients for Detergent Compositions

The preferred detergent according to the present invention is a powder or bar in solid form without water. A detergent composition according to the present invention preferably comprises the following ingredients: free perfume oil, particles of the present invention, one or more detersive surfactant, one or more detergency builder and optionally one or more additives as mentioned below.

The detergent compositions according to the present invention may comprise any of the ingredients customarily found in such compositions, such as, for example, anionic, nonionic, cationic, amphoteric or zwitterionic (co-)surfactants, organic solvents, builders, enzymes and additional auxiliaries such as soil repellents, thickeners, colorants and fragrances or the like.

### 2.1 Anionic (Co-)Surfactants

Preferably, surfactants of the sulfonate type, alk(en)yl sulfonates, alkoxylated alk(en)yl sulfates, ester sulfonates and/or soaps are used as the anionic surfactants. Suitable surfactants of the sulfonate type are advantageously C₉₋₁₃ alkylbenzene sulfonates, olefin sulfonates, i.e. mixtures of alkene- and hydroxyalkane sulfonates, and disulfonates, as are obtained, for example, by the sulfonation with gaseous sulfur trioxide of C₁₂₋₁₈ monoolefins having a terminal or internal double bond and subsequent alkaline or acidic hydrolysis of the sulfonation products.
(i) Alk(en)yl sulfates. Preferred alk(en)yl sulfates are the alkali and especially the sodium salts of the sulfuric acid half-esters of the C₁₂-C₁₈ fatty alcohols, for example, from coconut butter alcohol, tallow alcohol, lauryl, myristyl, cetyl or stearyl alcohol or from C₈-C₂₀ oxo alcohols and those half-esters of secondary alcohols of these chain lengths. Alk(en)yl sulfates of the cited chain lengths that comprise a synthetic straight chain alkyl group manufactured petrochemically are also preferred. The C₁₂-C₁₆ alkyl sulfates and C₁₂-C₁₅ alkyl sulfates as well as C₁₄-C₁₅ alkyl sulfates and C₁₄-C₁₆ alkyl sulfates are particularly preferred on the grounds of laundry performance. The 2,3-alkyl sulfates, which can be obtained from Shell Oil Company under the trade name DAN™, are also suitable anionic surfactants.
(ii) Alk(en)yl ether sulfates. Sulfuric acid mono-esters derived from straight-chained or branched C₇-C₂₁ alcohols ethoxylated with 1 to 6 moles ethylene oxide are also suitable, such as 2-methyl-branched C₉-C₁₁ alcohols with an average of 3.5 mol ethylene oxide (EO) or C₁₂-C₁₈ fatty alcohols with 1 to 4 EO.
(iii) Ester sulfonates. The esters of alpha-sulfo fatty acids (ester sulfonates), e.g., the alphasulfonated methyl esters of hydrogenated coco-, palm nut- or tallow acids are likewise suitable.
(iv) Soaps. Soaps, in particular, can be considered as further anionic surfactants. Saturated fatty acid soaps are particularly suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid. Those soap mixtures are particularly preferred that are composed of 50 to 100 wt. % of saturated C₁₂-C₂₄ fatty acid soaps and 0 to 50 wt. % of oleic acid soap.
(v) Ether carboxylic acids. A further class of anionic surfactants is that of the ether carboxylic acids, obtainable by treating fatty alcohol ethoxylates with sodium chloroacetate in the presence of basic catalysts. They have the general formula: RO(CH₂CH₂O)ₚCH₂COOH with R=C₁-C₁₈ and p=0.1 to 20. Ether carboxylic acids are insensitive to water hardness and possess excellent surfactant properties.

### 2.2 Non-Ionic (Co-)Surfactants

(i) Alkohol alkoxylates. The added nonionic surfactants are preferably alkoxylated and/or propoxylated, particularly primary alcohols having preferably 8 to 18 carbon atoms and an average of 1 to 12 mol ethylene oxide (EO) and/or 1 to 10 mol propylene oxide (PO) per mol alcohol. C₈-C₁₆-Alcohol alkoxylates, advantageously ethoxylated and/or propoxylated C₁₀-C₁₅-alcohol alkoxylates, particularly C₁₂-C₁₄ alcohol alkoxylates, with an ethoxylation degree between 2 and 10, preferably between 3 and 8, and/or a propoxylation degree between 1 and 6, preferably between 1.5 and 5, are particularly preferred. The cited degrees of ethoxylation and propoxylation constitute statistical average values that can be a whole or a fractional number for a specific product. Preferred alcohol ethoxylates and propoxylates have a narrowed homolog distribution (narrow range ethoxylates/propoxylates, NRE/NRP). In addition to these nonionic surfactants, fatty alcohols with more than 12 EO can also be used. Examples of these are (tallow) fatty alcohols with 14 EO, 16 EO, 20 EO, 25 EO, 30 EO or 40 EO.
(ii) Alkylglycosides (APG®). Furthermore, as additional nonionic surfactants, alkyl glycosides that satisfy the general Formula RO(G)ₓ, can be added, e.g., as compounds, particularly with anionic surfactants, in which R means a primary linear or methyl-branched, particularly 2-methyl-branched, aliphatic group containing 8 to 22, preferably 12 to 18 carbon atoms and G stands for a glycose unit containing 5 or 6 carbon atoms, preferably for glucose. The degree of oligomerization x, which defines the distribution of monoglycosides and oligoglycosides, is any number between 1 and 10, preferably between 1.1 and 1.4.
(iii) Fatty acid ester alkoxylates. Another class of preferred nonionic surfactants, which are used either as the sole nonionic surfactant or in combination with other nonionic surfactants, in particular, together with alkoxylated fatty alcohols and/or alkyl glycosides, are alkoxylated, preferably ethoxylated or ethoxylated and propoxylated fatty acid alkyl esters preferably containing 1 to 4 carbon atoms in the alkyl chain, more particularly the fatty acid methyl esters which are described, for example, in Japanese Patent Application JP-A-58/217598 or which are preferably produced by the process described in International Patent Application WO-A-90/13533. Methyl esters of C₁₂-C₁₈ fatty acids containing an average of 3 to 15 EO, particularly containing an average of 5 to 12 EO, are particularly preferred.
(iv) Amine oxides. Nonionic surfactants of the amine oxide type, for example, N-coco alkyl-N,N-dimethylamine oxide and N-tallow alkyl-N,N-dihydroxyethylamine oxide, and the fatty acid alkanolamides may also be suitable. The quantity in which these nonionic surfactants are used is preferably no more than the quantity in which the ethoxylated fatty alcohols are used and, particularly no more than half that quantity.
(v) Gemini surfactants. The so-called gemini surfactants can be considered as further surfactants. Generally speaking, such compounds are understood to mean compounds that have two hydrophilic groups and two hydrophobic groups per molecule. As a rule, these groups are separated from one another by a “spacer”. The spacer is usually a hydrocarbon chain that is intended to be long enough such that the hydrophilic groups are a sufficient distance apart to be able to act independently of one another. These types of surfactants are generally characterized by an unusually low critical micelle concentration and the ability to strongly reduce the surface tension of water. In exceptional cases, however, not only dimeric but also trimeric surfactants are meant by the term gemini surfactants. Suitable gemini surfactants are, for example, sulfated hydroxy mixed ethers according to German Patent Application DE 4321022 A1 or dimer alcohol bis- and trimer alcohol tris sulfates and ether sulfates according to International Patent Application WO 96/23768 A1. Blocked end group dimeric and trimeric mixed ethers according to German Patent Application DE 19513391 A1 are especially characterized by their bifunctionality and multifunctionality. Gemini polyhydroxyfatty acid amides or polyhydroxyfatty acid amides, such as those described in International Patent Applications WO 95/19953 A1, WO 95/19954 A1 and WO 95/19955 A1 can also be used.

### 2.3 Cationic Co-Surfactants

(i) Tetraalkyl ammonium salts. Cationically active surfactants comprise the hydrophobic high molecular group required for the surface activity in the cation by dissociation in aqueous solution. A group of important representatives of the cationic surfactants are the tetraalkyl ammonium salts of the general formula: (R¹R²R³R⁴N⁺) X⁻. Here R¹ stands for C₁-C₈ alk(en)yl, R², R³ and R⁴, independently of each other, for alk(en)yl radicals having 1 to 22 carbon atoms. X is a counter ion, preferably selected from the group of the halides, alkyl sulfates and alkyl carbonates. Cationic surfactants, in which the nitrogen group is substituted with two long acyl groups and two short alk(en)yl groups, are particularly preferred.
(ii) Esterquats. A further class of cationic surfactants particularly useful as co-surfactants for the present invention is represented by the so-called esterquats. Esterquats are generally understood to be quaternised fatty acid triethanolamine ester salts. These are known compounds which can be obtained by the relevant methods of preparative organic chemistry. Reference is made in this connection to International patent application WO 91/01295 A1, according to which triethanolamine is partly esterified with fatty acids in the presence of hypophosphorous acid, air is passed through the reaction mixture and the whole is then quaternised with dimethyl sulphate or ethylene oxide. In addition, German patent DE 4308794 C1 describes a process for the production of solid esterquats in which the quaternisation of triethanolamine esters is carried out in the presence of suitable dispersants, preferably fatty alcohols.
   Typical examples of esterquats suitable for use in accordance with the invention are products of which the acyl component derives from monocarboxylic acids corresponding to formula RCOOH in which RCO is an acyl group containing 6 to 10 carbon atoms, and the amine component is triethanolamine (TEA). Examples of such monocarboxylic acids are caproic acid, caprylic acid, capric acid and technical mixtures thereof such as, for example, so-called head-fractionated fatty acid. Esterquats of which the acyl component derives from monocarboxylic acids containing 8 to 10 carbon atoms, are preferably used. Other esterquats are those of which the acyl component derives from dicarboxylic acids like malonic acid, succinic acid, maleic acid, fumaric acid, glutaric acid, sorbic acid, pimelic acid, azelaic acid, sebacic acid and/or dodecanedioic acid, but preferably adipic acid. Overall, esterquats of which the acyl component derives from mixtures of monocarboxylic acids containing 6 to 22 carbon atoms, and adipic acid are preferably used. The molar ratio of mono and dicarboxylic acids in the final esterquat may be in the range from 1:99 to 99:1 and is preferably in the range from 50:50 to 90:10 and more particularly in the range from 70:30 to 80:20. Besides the quaternised fatty acid triethanolamine ester salts, other suitable esterquats are quaternized ester salts of mono-/dicarboxylic acid mixtures with diethanolalkyamines or 1,2-dihydroxypropyl dialkylamines. The esterquats may be obtained both from fatty acids and from the corresponding triglycerides in admixture with the corresponding dicarboxylic acids. One such process, which is intended to be representative of the relevant prior art, is proposed in European patent EP 0750606 B1. To produce the quaternised esters, the mixtures of mono- and dicarboxylic acids and the triethanolamine—based on the available carboxyl functions—may be used in a molar ratio of 1.1:1 to 3:1. With the performance properties of the esterquats in mind, a ratio of 1.2:1 to 2.2:1 and preferably 1.5:1 to 1.9:1 has proved to be particularly advantageous. The preferred esterquats are technical mixtures of mono-, di- and triesters with an average degree of esterification of 1.5 to 1.9.

### 2.4 Amphoteric or Zwitterionic Co-Surfactants

(i) Betaines. Amphoteric or ampholytic surfactants possess a plurality of functional groups that can ionize in aqueous solution and thereby—depending on the conditions of the medium—lend anionic or cationic character to the compounds (see DIN 53900, July 1972). Close to the isoelectric point (around pH 4), the amphoteric surfactants form inner salts, thus becoming poorly soluble or insoluble in water. Amphoteric surfactants are subdivided into ampholytes and betaines, the latter existing as zwitterions in solution. Ampholytes are amphoteric electrolytes, i.e. compounds that possess both acidic as well as basic hydrophilic groups and therefore behave as acids or as bases depending on the conditions. Especially betaines are known surfactants which are mainly produced by carboxyalkylation, preferably carboxymethylation, of amine compounds. The starting materials are preferably condensed with halocarboxylic acids or salts thereof, more particularly sodium chloroacetate, one mole of salt being formed per mole of betaine. The addition of unsaturated carboxylic acids, such as acrylic acid for example, is also possible. Examples of suitable betaines are the carboxy alkylation products of secondary and, in particular, tertiary amines which correspond to formula R¹R²R³N—(CH₂)_{q}COOX where R¹ is a an alkyl radical having 6 to 22 carbon atoms, R² is hydrogen or an alkyl group containing 1 to 4 carbon atoms, R³ is an alkyl group containing 1 to 4 carbon atoms, q is a number of 1 to 6 and X is an alkali and/or alkaline earth metal or ammonium. Typical examples are the carboxymethylation products of hexylmethylamine, hexyldimethylamine, octyldimethylamine, decyldimethylamine, C_{12/14}-cocoalkyldimethylamine, myristyldimethylamine, cetyldimethylamine, stearyldimethylamine, stearylethylmethylamine, oleyldimethylamine, C_{16/18}-tallowalkyldimethylamine and their technical mixtures, and particularly dodecyl methylamine, dodecyl dimethylamine, dodecyl ethylmethylamine and technical mixtures thereof.
(ii) Alkylamido betaines. Other suitable betaines are the carboxyalkylation products of amidoamines corresponding to formula R¹CO(R³)(R⁴)—NH—(CH₂)ₚ—N—(CH₂)_{q}COOX in which R¹CO is an aliphatic acyl radical having 6 to 22 carbon atoms and 0 or 1 to 3 double bonds, R² is hydrogen or an alkyl radical having 1 to 4 carbon atoms, R³ is an alkyl radical having 1 to 4 carbon atoms, p is a number from 1 to 6, q is a number from 1 to 3 and X is an alkali and/or alkaline earth metal or ammonium. Typical examples are reaction products of fatty acids having 6 to 22 carbon atoms, like for example caproic acid, caprylic acid, caprinic acid, lauric acid, myristic acid, palmitic acid, palmoleic acid, stearic acid, isostearic acid, oleic acid, elaidic acid, petroselinic acid, linolic acid linoleic acid, elaeostearic acid, arachidonic acid, gadoleic acid, behenic acid, erucic acid and their technical mixtures with N,N-dimethylaminoethylamine, N,N-dimethylaminopropylamine, N,N-diethylaminoethylamine and N,N-diethylaminopropylamine, which are condensed with sodium chloroacetate. The commercially available products include Dehyton® K and Dehyton® PK (Cognis Deutschland GmbH & Co., KG) as well as Tego®Betaine (Goldschmidt).
(iii) Imidazolines. Other suitable starting materials for the betaines to be used for the purposes of the invention are imidazolines. These substances are also known and may be obtained, for example, by cyclizing condensation of 1 or 2 moles of C₆⁻C₂₂ fatty acids with polyfunctional amines, such as for example aminoethyl ethanolamine (AEEA) or diethylenetriamine. The corresponding carboxyalkylation products are mixtures of different open-chain betaines. Typical examples are condensation products of the above-mentioned fatty acids with AEEA, preferably imidazolines based on lauric acid, which are subsequently betainised with sodium chloroacetate. The commercially available products include Dehyton® G (Cognis Deutschland GmbH & Co., KG)

The amount of (co-)surfactant comprised in the inventive compositions is advantageously 0.1 wt. % to 90 wt. %, particularly 10 wt. % to 80 wt. % and particularly preferably 20 wt. % to 70 wt.-%.

### 2.5 Organic Solvents

Liquid light or heavy duty detergents may comprise organic solvents, preferably those miscible with water. Polydiols, ethers, alcohols, ketones, amides and/or esters are preferably used as the organic solvent for this in amounts of 0 to 90 wt. %, preferably 0.1 to 70 wt. %, particularly 0.1 to 60 wt. %. Low molecular weight polar substances, such as for example, methanol, ethanol, propylene carbonate, acetone, acetonylacetone, diacetone alcohol, ethyl acetate, 2-propanol, ethylene glycol, propylene glycol, glycerin, diethylene glycol, dipropylene glycol monomethyl ether and dimethylformamide or their mixtures are preferred.

### 2.6 Enzymes

(i) Cellulase Enzymes. Cellulase enzymes optionally used in the instant detergent composition are preferably incorporated, when present, at levels sufficient to provide up to about 5 mg by weight, more preferably about 0.01 mg to about 3 mg, of active enzyme per gram of the composition. Unless stated otherwise, the compositions herein preferably comprise from about 0.001% to about 5%, preferably 0.01%-1% by weight of a commercial enzyme preparation.
   The cellulase suitable for the present invention include both bacterial or fungal cellulase. Preferably, they will have a pH optimum of between 5 and 9.5. Suitable cellulases are fungal cellulase produced from Humicola insolens and Humicola strain DSM1800 or a cellulase 212-producing fungus belonging to the genus Aeromonas, and cellulase extracted from the hepatopancreas of a marine mollusk (Dolabella Auricula Solander), suitable cellulases are also disclosed in GB 2,075,028 A. In addition, cellulase especially suitable for use herein are disclosed in WO 1992 013057 A1. Most preferably, the cellulases used in the instant detergent compositions are purchased commercially from NOVO Industries A/S under the product names CAREZYMEO and CELLUZYMEO.
(ii) Other Enzymes. Additional enzymes can be included in the detergent compositions herein for a wide variety of fabric laundering purposes, including removal of protein-based, carbohydrate-based, or triglyceride-based stains, for example, and for the prevention of refugee dye transfer, and for fabric restoration. The additional enzymes to be incorporated include proteases, amylases, lipases, and peroxidases, as well as mixtures thereof. Other types of enzymes can also be included. They can be of any suitable origin, such as vegetable, animal, bacterial, fungal and yeast origin. However, their choice is governed by several factors such as pH-activity and/or stability optima, thermostability, stability versus active detergents, builders as well as their potential to cause malodors during use. In this respect bacterial or fungal enzymes are preferred, such as bacterial amylases and proteaces.
   Enzymes are normally incorporated at levels sufficient to provide up to about 5 mg by weight, more typically about 0.01 mg to about 3 mg, of active enzyme per gram of the composition. Stated otherwise, the compositions herein will typically comprise from about 0.001% to about 5%, preferably 0.01%-1% by weight of a commercial enzyme preparation. Protease enzymes are usually present in such commercial preparations at levels sufficient to provide from 0.005 to 0.1 Anson units (AU) of activity per gram of composition.
   Suitable examples of proteases are the subtilisins which are obtained from particular strains of B. subtilis and B. licheniforms. Another suitable protease is obtained from a strain of Bacillus, having maximum activity throughout the pH range of 8-12, developed and sold by Novo Industries A/S under the registered trade name ESPERASE®. The preparation of this enzyme and analogous enzymes is described in GB 1,243,784 of Novo. Proteolytic enzymes suitable for removing protein-based stains that are commercially available include those sold under the trade names ALCALASE® and SAVINASE® by Novo Industries A/S and MAXATASE® by International Bio-Synthetics, Inc. Other proteases include Protease A; Protease B and proteases made by Genencor International, Inc., according to U.S. Pat. No. 5,204,015 and U.S. Pat. No. 5,244,791.

Amylases include, for example, alpha-amylases like RAPIDASE®, International Bio-Synthetics, Inc. and TERMAMYL®, Novo Industries.

Suitable lipase enzymes for detergent usage include those produced by microorganisms of the Pseudomonas group, such as Pseudomonas stutzeri ATCC 19154. This lipase is available from Amano Pharmaceutical Co. Ltd., under the trade name Lipase P “Amano”. Other commercial lipases include Amano-CES, lipases ex Chromobacter viscosum, e.g. Chromobacter viscosum var. lipolyticum NRRLB 3673, commercially available from Toyo Jozo Co., and further Chromobacter viscosum lipases from U.S. Biochemical Corp. and Disoynth Co., and lipases ex Pseudomonas gladioli. The LIPOLASE® enzyme derived from Humicola lanuginosa (commercially available from Novo Industries A/S) is a preferred lipase for use herein.

Peroxidase enzymes are used in combination with oxygen sources, e.g., percarbonate, perborate, persulfate, hydrogen peroxide, etc. They are used for “solution bleaching,” i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase. Peroxidase-containing detergent compositions are disclosed, for example, in WO 1989 099813 A1.
(iii) Enzyme Stabilizers. The enzymes employed herein are stabilized by the presence of water-soluble sources of calcium and/or magnesium ions in the finished detergent compositions which provide such ions to the enzymes. (Calcium ions are generally somewhat more effective than magnesium ions and are preferred herein if only one type of cation is being used.) Additional stability can be provided by the presence of various other art-disclosed stabilizers, especially borate species, see U.S. Pat. No. 4,537,706, incorporated herein in its entirety. Typical detergents, especially liquids, will comprise from about 1 to about 30, preferably from about 2 to about 20, more preferably from about 5 to about 15, and most preferably from about 8 to about 12, millimoles of calcium ion per liter of finished composition. In solid detergent compositions the formulation can include a sufficient quantity of a water-soluble calcium ion source to provide such amounts in the laundry liquor. In the alternative, natural water hardness can suffice.
   It is to be understood that the foregoing levels of calcium and/or magnesium ions are sufficient to provide enzyme stability. More calcium and/or magnesium ions can be added to the compositions to provide an additional measure of grease removal performance. Accordingly, as a general proposition the compositions herein will typically comprise from about 0.05% to about 2% by weight of a water-soluble source of calcium or magnesium ions, or both. The amount can vary, of course, with the amount and type of enzyme employed in the composition.
   The compositions herein can also optionally, but preferably, contain various additional stabilizers, especially borate-type stabilizers. Typically, such stabilizers will be used at levels in the compositions from about 0.25% to about 10%, preferably from about 0.5% to about 5%, more preferably from about 0.75% to about 3%, by weight of boric acid or other borate compound capable of forming boric acid in the composition (calculated on the basis of boric acid). Boric acid is preferred, although other compounds such as boric oxide, borax and other alkali metal borates (e.g., sodium ortho-, meta- and pyroborate, and sodium pentaborate) are suitable. Substituted boric acids (e.g., phenylboronic acid, butane boronic acid, and p-bromo phenylboronic acid) can also be used in place of boric acid.

### 2.7 Builders

(i) Zeolites. Fine crystalline, synthetic zeolites containing bound water can be used as builders, for example, preferably zeolite A and/or P. Zeolite MAP.RTM. (commercial product of the Crosfield company), is particularly preferred as the zeolite P. However, zeolite X and mixtures of A, X, Y and/or P are also suitable. A co-crystallized sodium/potassium aluminum silicate from Zeolite A and Zeolite X, which is available as Vegobond® RX. (commercial product from Condea Augusta S.p.A.), is also of particular interest. Preferably, the zeolite can be used as a spray-dried powder. For the case where the zeolite is added as a suspension, this can comprise small amounts of nonionic surfactants as stabilizers, for example, 1 to 3 wt. %, based on the zeolite, of ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have an average particle size of less than 10 μm (test method: volumetric distribution Coulter counter) and preferably comprise 18 to 22 wt. %, particularly 20 to 22 wt. % of bound water. Apart from this, phosphates can also be used as builders.
(ii) Layered silicates. Suitable substitutes or partial substitutes for phosphates and zeolites are crystalline, layered sodium silicates. These types of crystalline layered silicates are described, for example, in European Patent Application EP 0164514 A1. Preferred crystalline layered silicates are those obtained for example, from the process described in International Patent Application WO 91/08171 A1.
(iii) Amorphous silicates. Preferred builders also include amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example, by surface treatment, compounding, compressing/compacting or by over-drying. In the context of this invention, the term “amorphous” also means “X-ray amorphous”. In other words, the silicates do not produce any of the sharp X-ray reflexions typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This is to be interpreted to mean that the products have microcrystalline regions between 10 and a few hundred nm in size, values of up to at most 50 nm and especially up to at most 20 nm being preferred. This type of X-ray amorphous silicates, which similarly possess a delayed dissolution in comparison with the customary water glasses, are described, for example, in German Patent Application DE 4400024 A1. Compacted/densified amorphous silicates, compounded amorphous silicates and over dried X-ray-amorphous silicates are particularly preferred.
(iv) Phosphates. Also the generally known phosphates can also be added as builders, in so far that their use should not be avoided on ecological grounds. The sodium salts of the orthophosphates, the pyrophosphates and especially the tripolyphosphates are particularly suitable. Their content is generally not more than 25 wt. %, preferably not more than 20 wt. %, each based on the finished composition. In some cases it has been shown that particularly tripolyphosphates, already in low amounts up to maximum 10 wt. %, based on the finished composition, in combination with other builders, lead to a synergistic improvement of the secondary washing power. Preferred amounts of phosphates are under 10 wt. %, particularly 0 wt. %.

### 2.8 Cobuilders

(i) Polycarboxylic acids. Useful organic cobuilders are, for example, the polycarboxylic acids usable in the form of their sodium salts of polycarboxylic acids, wherein polycarboxylic acids are understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA) and its derivatives and mixtures thereof. Preferred salts are the salts of polycarboxylic acids such as citric acid, adipic acid, succinic acid, glutaric acid, tartaric acid, sugar acids and mixtures thereof.
(ii) Organic acids. Acids per se can also be used. Besides their building effect, the acids also typically have the property of an acidifying component and, hence also serve to establish a relatively low and mild pH in detergents or cleansing compositions. Citric acid, succinic acid, glutaric acid, adipic acid, gluconic acid and any mixtures thereof are particularly mentioned in this regard. Further suitable acidifiers are the known pH regulators such as sodium hydrogen carbonate and sodium hydrogen sulfate.
(iii) Polymers. Particularly suitable polymeric cobuilders are polyacrylates, which preferably have a molecular weight of 2,000 to 20,000 g/mol. By virtue of their superior solubility, preferred representatives of this group are again the short-chain polyacrylates, which have molecular weights of 2,000 to 10,000 g/mol and, more particularly, 3,000 to 5,000 g/mol. Suitable polymers can also include substances that consist partially or totally of vinyl alcohol units or its derivatives.
   Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2,000 to 70,000 g/mol, preferably 20,000 to 50,000 g/mol and especially 30,000 to 40,000 g/mol. The (co)polymeric polycarboxylates can be added either as an aqueous solution or preferably as powder. In order to improve the water solubility, the polymers can also comprise allylsulfonic acids as monomers, such as, for example, allyloxybenzene sulfonic acid and methallyl sulfonic acid as in the EP 0727448 B1
   Biodegradable polymers comprising more than two different monomer units are particularly preferred, examples being those comprising, as monomers, salts of acrylic acid and of maleic acid, and also vinyl alcohol or vinyl alcohol derivatives, as in DE 4300772 A1, or those comprising, as monomers, salts of acrylic acid and of 2-alkylallyl sulfonic acid, and also sugar derivatives. Further preferred copolymers are those that are described in German Patent Applications DE 4303320 A1 and DE 4417734 A1 and preferably include α-rolein and acrylic acid/acrylic acid salts or acrolein and vinyl acetate as monomers.
   Similarly, other preferred builders are polymeric aminodicarboxylic acids, salts or precursors thereof. Those polyaspartic acids or their salts and derivatives disclosed in German Patent Application DE 19540086 A1 as having a bleach-stabilizing action in addition to cobuilder properties are particularly preferred.
   Further suitable builders are polyacetals that can be obtained by treating dialdehydes with polyol carboxylic acids that possess 5 to 7 carbon atoms and at least 3 hydroxyl groups, as described in European Patent Application EP 0280223 A1. Preferred polyacetals are obtained from dialdehydes like glyoxal, glutaraldehyde, terephthalaldehyde as well as their mixtures and from polycarboxylic acids like gluconic acid and/or glucoheptonic acid.
(iv) Carbohydrates. Further suitable organic cobuilders are dextrins, for example, oligomers or polymers of carbohydrates that can be obtained by the partial hydrolysis of starches. The hydrolysis can be carried out using typical processes, for example, acidic or enzymatic catalyzed processes. The hydrolysis products preferably have average molecular weights in the range of 400 to 500,000 g/mol. A polysaccharide with a dextrose equivalent (DE) of 0.5 to 40 and, more particularly, 2 to 30 is preferred, the DE being an accepted measure of the reducing effect of a polysaccharide in comparison with dextrose, which has a DE of 100. Both maltodextrins with a DE between 3 and 20 and dry glucose syrups with a DE between 20 and 37 and also so-called yellow dextrins and white dextrins with relatively high molecular weights of 2,000 to 30,000 g/mol may be used. A preferred dextrin is described in British Patent Application 94 19 091.
   The oxidized derivatives of such dextrins concern their reaction products with oxidizing compositions that are capable of oxidizing at least one alcohol function of the saccharide ring to the carboxylic acid function. Such oxidized dextrins and processes for their manufacture are known for example, from European Patent Applications EP 0232202 A1. A product oxidized at C6 of the saccharide ring can be particularly advantageous.
(v) Oxydisuccinates and other derivatives of disuccinates, preferably ethylenediamine disuccinate are also further suitable cobuilders. Here, ethylene diamine-N,N′-disuccinate (EDDS), the synthesis of which is described for example, in U.S. Pat. No. 3,158,615, is preferably used in the form of its sodium or magnesium salts. In this context, glycerine disuccinates and glycerine trisuccinates are also particularly preferred, such as those described in U.S. Pat. No. 4,524,009. Suitable addition quantities in zeolite-containing and/or silicate-containing formulations range from 3 to 15% by weight.
(vi) Lactones. Other useful organic co-builders are, for example, acetylated hydroxycarboxylic acids and salts thereof which optionally may also be present in lactone form and which contain at least 4 carbon atoms, at least one hydroxyl group and at most two acid groups. Such cobuilders are described, for example, in International Patent Application WO 1995 020029 A1.

### 2.9 Bleaching Compounds, Bleaching Agents and Bleach Activators

The detergent compositions herein can optionally contain bleaching agents or bleaching compositions containing a bleaching agent and one or more bleach activators. When present, bleaching agents will typically be at levels of from about 1% to about 30%, more typically from about 5% to about 20%, of the detergent composition, especially for fabric laundering. If present, the amount of bleach activators will typically be from about 0.1% to about 60%, more typically from about 0.5% to about 40% of the bleaching composition comprising the bleaching agent-plus-bleach activator.

The bleaching agents used herein can be any of the bleaching agents useful for detergent compositions in textile cleaning, hard surface cleaning, or other cleaning purposes that are now known or become known. These include oxygen bleaches as well as other bleaching agents. Perborate bleaches, e.g., sodium perborate (e.g., mono- or tetra-hydrate) can be used herein.

Another category of bleaching agent that can be used without restriction encompasses percarboxylic acid bleaching agents and salts thereof. Suitable examples of this class of agents include magnesium monoperoxyphthalate hexahydrate, the magnesium salt of meta-chloro perbenzoic acid, 4-nonylamino-4-oxoperoxybutyric acid and diperoxydodecanedioic acid.

Peroxygen bleaching agents can also be used. Suitable peroxygen bleaching compounds include sodium carbonate peroxyhydrate and equivalent “percarbonate” bleaches, sodium pyrophosphate peroxyhydrate, urea peroxyhydrate, and sodium peroxide. Persulfate bleach (e.g., OXONEO®, manufactured commercially by DuPont) can also be used.

A preferred percarbonate bleach comprises dry particles having an average particle size in the range from about 500 micrometers to about 1,000 micrometers, not more than about 10% by weight of said particles being smaller than about 200 micrometers and not more than about 10% by weight of said particles being larger than about 1,250 micrometers. Optionally, the percarbonate can be coated with silicate, borate or water-soluble surfactants. Percarbonate is available from various commercial sources.

Mixtures of bleaching agents can also be used.

Peroxygen bleaching agents, the perborates, the percarbonates, etc., are preferably combined with bleach activators, which lead to the in situ production in aqueous solution (i.e., during the washing process) of the peroxy acid corresponding to the bleach activator. The nonanoyloxybenzene sulfonate (NOBS) and tetraacetyl ethylene diamine (TAED) activators are typical, and mixtures thereof can also be used.

Preferred amido-derived bleach activators include (6-octanamido-caproyl)oxyben-zenesulfonate, (6-nonanamidocaproyl)oxybenzenesulfonate, (6-decanamido-caproyl)oxybenzenesulfonate, and mixtures thereof.

Another class of bleach activators comprises the benzoxazin-type activators disclosed in U.S. Pat. No. 4,966,723, incorporated herein by reference.

Highly preferred lactam activators include benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof, optionally adsorbed into solid carriers, e.g. acyl caprolactams, preferably benzoyl caprolactam, adsorbed into sodium perborate.

Bleaching agents other than oxygen bleaching agents are also known in the art and can be utilized herein. One type of non-oxygen bleaching agent of particular interest includes photoactivated bleaching agents such as the sulfonated zinc and/or aluminum phthalocyanines. If used, detergent compositions will typically contain from about 0.025% to about 1.25%, by weight, of such bleaches, especially sulfonate zinc phthalocyanine.

If desired, the bleaching compounds can be catalyzed by means of a manganese compound. Such manganese-based catalysts are well known in the art and include Mn^{IV}₂ (u-O)₃ (1,4,7-trimethyl-1,4,7-triazacyclononane)₂ (PF₆)₂, Mn^{III}₂ (u-O)₁ (u-OAc)₂ (1,4,7-trimethyl-1,4,7-triazacyclononane)₂(ClO₄)₂, Mn^{IV}₄ (u-O)₆ (1,4,7-triazacyclononane)₄ (CIO₄)₄, Mn^{III}Mn^{IV}₄(u-O)₁ (u-OAc)₂ (1,4,7-trimethyl-1,4,7-triazacyclononane)₂ (ClO₄)₃, Mn^{IV} (1,4,7-trimethyl-1,4,7-triazacyclononane)-(OCH₃)₃ (PF₆), and mixtures thereof.

As a practical matter, and not by way of limitation, the compositions and processes herein can be adjusted to provide on the order of at least one part per ten million of the active bleach catalyst species in the aqueous washing liquor, and will preferably provide from about 0.1 ppm to about 700 ppm, more preferably from about 1 ppm to about 500 ppm, of the catalyst species in the laundry liquor.

### 2.10 Polymeric Soil Release Agents

Any polymeric soil release agent known to those skilled in the art can optionally be employed in the detergent compositions and processes of this invention. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of washing and rinsing cycles and, thus, serve as an anchor for the hydrophilic segments. This can enable stains occurring subsequent to treatment with the soil release agent to be more easily cleaned in later washing procedures.

The polymeric soil release agents useful herein especially include those soil release agents having: (a) one or more nonionic hydrophile components consisting essentially of (i) polyoxyethylene segments with a degree of polymerization of at least 2, or (ii) oxypropylene or polyoxypropylene segments with a degree of polymerization of from 2 to 10, wherein said hydrophile segment does not encompass any oxypropylene unit unless it is bonded to adjacent moieties at each end by ether linkages, or (iii) a mixture of oxyalkylene units comprising oxyethylene and from 1 to about 30 oxypropylene units wherein said mixture contains a sufficient amount of oxyethylene units such that the hydrophile component has hydrophilicity great enough to increase the hydrophilicity of conventional polyester synthetic fiber surfaces upon deposit of the soil release agent on such surface, said hydrophile segments preferably comprising at least about 25% oxyethylene units and more preferably, especially for such components having about 20 to 30 oxypropylene units, at least about 50% oxyethylene units; or (b) one or more hydrophobe components comprising (i) C₃ oxyalkylene terephthalate segments, wherein, if said hydrophobe components also comprise oxyethylene terephthalate, the ratio of oxyethylene terephthalate: C₃ oxyalkylene terephthalate units is about 2:1 or lower, (ii) C₄-C₆ alkylene or oxy C₄-C₆ alkylene segments, or mixtures therein, (iii) poly(vinyl ester) segments, preferably polyvinyl acetate), having a degree of polymerization of at least 2, or (iv) C₁-C₄ alkyl ether or C₄ hydroxyalkyl ether substituents, or mixtures therein, wherein said substituents are present in the form of C₁-C₄ alkyl ether or C₄ hydroxyalkyl ether cellulose derivatives, or mixtures therein, and such cellulose derivatives are amphiphilic, whereby they have a sufficient level of C₁-C₄ alkyl ether and/or C₄ hydroxyalkyl ether units to deposit upon conventional polyester synthetic fiber surfaces and retain a sufficient level of hydroxyls, once adhered to such conventional synthetic fiber surface, to increase fiber surface hydrophilicity, or a combination of (a) and (b).

Typically, the polyoxyethylene segments of (a) (i) will have a degree of polymerization of from about 200, although higher levels can be used, preferably from 3 to about 150, more preferably from 6 to about 100. Suitable oxy C₄-C₆ alkylene hydrophobe segments include, but are not limited to, end-caps of polymeric soil release agents.

Polymeric soil release agents useful in the present invention also include cellulosic derivatives such as hydroxyether cellulosic polymers, copolymeric blocks of ethylene terephthalate or propylene terephthalate with polyethylene oxide or polypropylene oxide terephthalate, and the like. Such agents are commercially available and include hydroxyethers of cellulose such as METHOCEL® (Dow). Cellulosic soil release agents for use herein also include those selected from the group consisting of C₁-C₄ alkyl and C₄ hydroxyalkyl cellulose.

Soil release agents characterized by poly(vinyl ester) hydrophobe segments include graft copolymers of poly(vinyl ester), e.g., C₁-C₆ vinyl esters, preferably poly(vinyl acetate) grafted onto polyalkylene oxide backbones, such as polyethylene oxide backbones, see EP 0 219 048, incorporated herein in its entirety. Commercially available soil release agents of this kind include the SOKALAN® type of material, e.g., SOKALAN® HP-22, available from BASF.

One type of preferred soil release agent is a copolymer having random blocks of ethylene terephthalate and polyethylene oxide (PEO) terephthalate. The molecular weight of this polymeric soil release agent preferably is in the range of from about 25,000 to about 55,000.

Another preferred polymeric soil release agent is a polyester with repeat units of ethylene terephthalate units contains 10-15% by weight of ethylene terephthalate units together with 90-80% by weight of polyoxyethylene terephthalate units, derived from a polyoxyethylene glycol of average molecular weight 300-5,000. Examples of this polymer include the commercially available material ZELCON® 5126 (from DuPont) and MILEASE® T (from ICI).

Another preferred polymeric soil release agent is a sulfonated product of a substantially linear ester oligomer comprised of an oligomeric ester backbone of terephthaloyl and oxyalkyleneoxy repeat units and terminal moieties covalently attached to the backbone. These soil release agents are described fully in U.S. Pat. No. 4,968,451. Other suitable polymeric soil release agents include the terephthalate polyesters of U.S. Pat. No. 4,711,730, the anionic end-capped oligomeric esters of U.S. Pat. No. 4,721,580, the block polyester oligomeric compounds of U.S. Pat. No. 4,702,857, and anionic, especially sulfoaroyl, end-capped terephthalate esters of U.S. Pat. No. 4,877,896 all cited patents incorporated herein in their entirety.

Still another preferred soil release agent is an oligomer with repeat units of terephthaloyl units, sulfoisoterephthaloyl units, oxyethyleneoxy and oxy-1,2-propylene units. The repeat units form the backbone of the oligomer and are preferably terminated with modified isethionate endcaps. A particularly preferred soil release agent of this type comprises about one sulfoisophthaloyl unit, 5 terephthaloyl units, oxyethyleneoxy and oxy-1,2-propyleneoxy units in a ratio of from about 1.7 to about 1.8, and two end-cap units of sodium 2-(2-hydroxyethoxy)ethanesulfonate. Said soil release agent also comprises from about 0.5% to about 20%, by weight of the oligomer, of a crystalline-reducing stabilizer, preferably selected from the group consisting of xylene sulfonate, cumene sulfonate, toluene sulfonate, and mixtures thereof.

If utilized, soil release agents will generally comprise from about 0.01% to about 10.0%, by weight, of the detergent compositions herein, typically from about 0.1% to about 5%, preferably from about 0.2% to about 3.0%.

### 2.11 Polymeric Dispersing Agents

Polymeric dispersing agents can advantageously be utilized at levels from about 0.1% to about 7%, by weight, in the detergent compositions herein, especially in the presence of zeolite and/or layered silicate builders. Suitable polymeric dispersing agents include polymeric polycarboxylates and polyethylene glycols, although others known in the art can also be used. It is believed, though it is not intended to be limited by theory, that polymeric dispersing agents enhance overall detergent builder performance, when used in combination with other builders (including lower molecular weight polycarboxylates) by crystal growth inhibition, particulate soil release peptization, and anti-redeposition.

Polymeric polycarboxylate materials can be prepared by polymerizing or copolymerizing suitable unsaturated monomers, preferably in their acid form. Unsaturated monomeric acids that can be polymerized to form suitable polymeric polycarboxylates include acrylic acid, maleic acid (or maleic anhydride), fumaric acid, itaconic acid, aconitic acid, mesaconic acid, citraconic acid and methylenemalonic acid. The presence in the polymeric polycarboxylates herein or monomeric segments, containing no carboxylate radicals such as vinylmethyl ether, styrene, ethylene, etc. is suitable provided that such segments do not constitute more than about 40% by weight.

Particularly suitable polymeric polycarboxylates can be derived from acrylic acid. Such acrylic acid-based polymers which are useful herein are the water-soluble salts of polymerized acrylic acid. The average molecular weight of such polymers in the acid form preferably ranges from about 2,000 to 10,000, more preferably from about 4,000 to 7,000 and most preferably from about 4,000 to 5,000. Water-soluble salts of such acrylic acid polymers can include, for example, the alkali metal, ammonium and substituted ammonium salts. Soluble polymers of this type are known materials. Use of polyacrylates of this type in detergent compositions has been disclosed, for example U.S. Pat. No. 3,308,067.

Acrylic/maleic-based copolymers can also be used as a preferred component of the dispersing/anti-redeposition agent. Such materials include the water-soluble salts of copolymers of acrylic acid and maleic acid. The average molecular weight of such copolymers in the acid form preferably ranges from about 2,000 to 100,000, more preferably from about 5,000 to 75,000, most preferably from about 7,000 to 65,000. The ratio of acrylate to maleate segments in such copolymers will generally range from about 30:1 to about 1:1, more preferably from about 10:1 to 2:1. Water-soluble salts of such acrylic acid/maleic acid copolymers can include, for example, the alkali metal, ammonium and substituted ammonium salts. Soluble acrylate/maleate copolymers of this type are known materials which are described in EP 0193360 A1, which also describes such polymers comprising hydroxypropylacrylate. Still other useful dispersing agents include the maleic/acrylic/vinyl alcohol terpolymers, for example, a 45/45/10 terpolymer of acrylic/maleic/vinyl alcohol.

Another polymeric material which can be included is polyethylene glycol (PEG). PEG can exhibit dispersing agent performance as well as act as a clay soil removal-antiredeposition agent. Typical molecular weight ranges for these purposes range from about 500 to about 100,000, preferably from about 1,000 to about 50,000, more preferably from about 1,500 to about 10,000.

Polyaspartate and polyglutamate dispersing agents can also be used, especially in conjunction with zeolite builders. Dispersing agents such as polyaspartate preferably have a molecular weight (avg.) of about 10,000.

### 2.12 Foam Inhibitors/Sud Supressors

Especially when used in automatic washing processes, it can be advantageous to add conventional foam inhibitors to the compositions. Suitable foam inhibitors include for example, soaps of natural or synthetic origin, which have a high content of C₁₈-C₂₄ fatty acids. Suitable non-surface-active types of foam inhibitors are, for example, organopolysiloxanes and mixtures thereof with microfine, optionally silanised silica and also paraffins, waxes, microcrystalline waxes and mixtures thereof with silanised silica or bis-stearyl ethylenediamide. Mixtures of various foam inhibitors, for example, mixtures of silicones, paraffins or waxes, are also used with advantage. Preferably, the foam inhibitors, especially silicone-containing and/or paraffin-containing foam inhibitors, are loaded onto a granular, water-soluble or dispersible carrier material. Especially in this case, mixtures of paraffins and bis-stearylethylene diamides are preferred.

Compounds for reducing or suppressing the formation of suds can be incorporated into the detergent compositions of the present invention. Suds suppression can be of particular importance in the so-called “high concentration cleaning process” and in front-loading European-style washing machines.

A wide variety of materials can be used as suds suppressors, and suds suppressors are well known to those skilled in the art. See, for example, Kirk Othmer Encyclopedia of Chemical Technology, Third Edition, Volume 7, pages 430-447 (John Wiley & Sons, Inc., 1979). One category of suds suppressor of particular interest encompasses monocarboxylic fatty acid and soluble salts therein. The monocarboxylic fatty acids and salts thereof used as suds suppressor typically have hydrocarbyl chains of 10 to about 24 carbon atoms, preferably 12 to 18 carbon atoms. Suitable salts include the alkali metal salts such as sodium, potassium, and lithium salts, and ammonium and alkanolammonium salts.

The detergent compositions herein can also contain non-surfactant suds suppressors. These include, for example: high molecular weight hydrocarbons such as paraffin, fatty acid esters (e.g., fatty acid triglycerides), fatty acid esters of monovalent alcohols, aliphatic C₁₈-C₄₀ ketones (e.g., stearone), etc. Other suds inhibitors include N-alkylated amino triazines such as tri- to hexa-alkylmelamines or di- to tetra-alkyldiamine chlortriazines formed as products of cyanuric chloride with two or three moles of a primary or secondary amine containing 1 to 24 carbon atoms, propylene oxide, and monostearyl phosphates such as monostearyl alcohol phosphate ester and monostearyl di-alkali metal (e.g., K, Na, and Li) phosphates and phosphate esters. The hydrocarbons such as paraffin and haloparaffin can be utilized in liquid form. The liquid hydrocarbons will be liquid at room temperature and atmospheric pressure, and will have a pour point in the range of about −40° C. and about 50° C., and a minimum boiling point not less than about 110° C. (atmospheric pressure). It is also known to utilize waxy hydrocarbons, preferably having a melting point below about 100° C. Hydrocarbon suds suppressors are known in the art and include aliphatic, alicyclic, aromatic, and heterocyclic saturated or unsaturated hydrocarbons having from about 12 to about 70 carbon atoms. The term “paraffin,” as used in this suds suppressor discussion, is intended to include mixtures of true paraffins and cyclic hydrocarbons.

Another preferred category of non-surfactant suds suppressors comprises silicone suds suppressors. This category includes the use of polyorganosiloxane oils, such as polydimethylsiloxane, dispersions or emulsions of polyorganosiloxane oils or resins, and combinations of polyorganosiloxane with silica particles wherein the polyorganosiloxane is chemisorbed or fused onto the silica. Silicone suds suppressors are well known in the art.

Other silicone suds suppressors are disclosed in U.S. Pat. No. 3,455,839, incorporated herein in its entirety, which relates to compositions and processes for defoaming aqueous solutions by incorporating therein small amounts of polydimethylsiloxane fluids.

Mixtures of silicone and silanated silica are described, for instance, in DE-OS 2124526, incorporated herein in its entirety. Silicone defoamers and suds controlling agents in granular detergent compositions are disclosed in U.S. Pat. No. 4,652,392, incorporated herein in its entirety.

In the preferred silicone suds suppressor used herein, the solvent for a continuous phase is made up of certain polyethylene glycols or polyethylene-polypropylene glycol copolymers or mixtures thereof (preferred), or polypropylene glycol. The primary silicone suds suppressor is branched/crosslinked and preferably not linear.

The silicone suds suppressor herein preferably comprises polyethylene glycol and a copolymer of polyethylene glycol/polypropylene glycol, all having an average molecular weight of less than about 1,000, preferably between about 100 and 800. The polyethylene glycol and polyethylene/polypropylene copolymers herein have a solubility in water at room temperature of more than about 2 weight %, preferably more than about 5 weight %.

The preferred solvent herein is polyethylene glycol having an average molecular weight of less than about 1,000, more preferably between about 100 and 800, most preferably between 200 and 400, and a copolymer of polyethylene glycol/polypropylene glycol, preferably PPG 200/PEG 300. Preferred is a weight ratio of between about 1:1 and 1:10, most preferably between 1:3 and 1:6, of polyethylene glycol:copolymer of polyethylene-polypropylene glycol.

The preferred silicone suds suppressors used herein do not contain polypropylene glycol, particularly of 4,000 molecular weight. They also preferably do not contain block copolymers of ethylene oxide and propylene oxide, like PLURONIC® L101.

Other suds suppressors useful herein comprise the secondary alcohols (e.g., 2-alkyl alkanols) and mixtures of such alcohols with silicone oils. The secondary alcohols include the C₆-C₁₆ alkyl alcohols having a C₁-C₁₆ chain. A preferred alcohol is 2-butyl octanol, which is available from Condea under the trademark ISOFOL® 12. Mixtures of secondary alcohols are available under the trademark ISALCHEM® 123 from Enichem. Mixed suds suppressors typically comprise mixtures of alcohol+silicone at a weight ratio of 1:5 to 5:1.

The compositions herein will generally comprise from 0% to about 5% of suds suppressor. When utilized as suds suppressors, monocarboxylic fatty acids, and salts therein, will be present typically in amounts up to about 5%, by weight, of the detergent composition. Preferably, from about 0.5% to about 3% of fatty monocarboxylate suds suppressor is utilized. Silicone suds suppressors are typically utilized in amounts up to about 2.0%, by weight, of the detergent composition, although higher amounts can be used. This upper limit is practical in nature, due primarily to concern with keeping costs minimized and effectiveness of lower amounts for effectively controlling sudsing. Preferably from about 0.01% to about 1% of silicone suds suppressor is used, more preferably from about 0.25% to about 0.5%. As used herein, these weight percentage values include any silica that can be utilized in combination with polyorganosiloxane, as well as any adjunct materials that can be utilized. Monostearyl phosphate suds suppressors are generally utilized in amounts ranging from about 0.1% to about 2%, by weight, of the composition. Hydrocarbon suds suppressors are typically utilized in amounts ranging from about 0.01% to about 5.0%, although higher levels can be used. The alcohol suds suppressors are typically used at 0.2%-3% by weight of the finished compositions.

### 2.13 Sequestrants and Chelating Agents

The salts of polyphosphonic acid can be considered as sequestrants or as stabilizers, particularly for peroxy compounds and enzymes, which are sensitive towards heavy metal ions. Here, the sodium salts of, for example, 1-hydroxyethane-1,1-diphosphonate, diethylenetriamine pentamethylene phosphonate or ethylenediamine tetramethylene phosphonate are used in amounts of 0.1 to 5 wt. %.

The detergent compositions herein can also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates. It is understood that some of the detergent builders described hereinbefore can function as chelating agents and is such detergent builder is present in a sufficient quantity, it can provide both functions.

Amino carboxylates useful as optional chelating agents include ethylenediaminetetracetates, N-hydroxyethylethylenediaminetriacetates, nitrilotriacetates, ethylenediamine tetraproprionates, triethylenetetraaminehexacetates, diethylenetriaminepentaacetates, and ethanoldiglycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylenediaminetetrakis(methylenephosphonates) as DEQUEST. Preferred, these amino phosphonates to not contain alkyl or alkenyl groups with more than about 6 carbon atoms.

Polyfunctionally-substituted aromatic chelating agents are also useful in the compositions herein. Preferred compounds of this type in acid form are dihydroxydisulfobenzenes such as 1,2-dihydroxy-3,5-disulfobenzene.

A preferred biodegradable chelator for use herein is ethylenediamine disuccinate (“EDDS”), especially the [S,S] isomer.

If utilized, these chelating agents will generally comprise from about 0.1% to about 10% by weight of the detergent compositions herein. More preferably, if utilized, the chelating agents will comprise from about 0.1% to about 3.0% by weight of such compositions.

### 2.14 Clay Soil Removal/Anti-Redeposition Agents

The detergent compositions of the present invention can also optionally contain water-soluble ethoxylated amines having clay soil removal and antiredeposition properties. Granular detergent compositions which contain these compounds typically contain from about 0.01% to about 10.0% by weight of the water-soluble ethoxylates amines; liquid detergent compositions typically contain about 0.01% to about 5%.

The most preferred soil release and anti-redeposition agent is ethoxylated tetraethylenepentamine. Exemplary ethoxylated amines are further described in U.S. Pat. No. 4,597,898. Other groups of preferred clay soil removal-antiredeposition agents are the cationic compounds disclosed in EP 0111965 A1, the ethoxylated amine polymers disclosed in EP 0111984 A1, the zwitterionic polymers disclosed in EP 0112592 A1, and the amine oxides disclosed in U.S. Pat. No. 4,548,744. Another type of preferred antiredeposition agent includes the carboxy methyl cellulose (CMC) materials. These materials are well known in the art.

### 2.15 Graying Inhibitors

Graying inhibitors have the function of maintaining the dirt that was removed from the fibers suspended in the washing liquor, thereby preventing the dirt from resettling. Water-soluble colloids of mostly organic nature are suitable for this, for example, the water-soluble salts of (co)polymeric carboxylic acids, glue, gelatins, salts of ether carboxylic acids or ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the above-mentioned starch products, e.g., degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl celluloses and mixed ethers such as methyl hydroxyethyl cellulose, methyl hydroxypropyl cellulose, methyl carboxymethyl cellulose and mixtures thereof, as well as polyvinyl pyrrolidone, which can be added, for example, in amounts of 0.1 to 5 wt. %, based on the composition.

### 2.16 Optical Brighteners and UV Adsorbers

Any optical brighteners or other brightening or whitening agents known in the art can be incorporated at levels typically from about 0.05% to about 1.2%, by weight, into the detergent compositions herein. Commercial optical brighteners which can be useful in the present invention can be classified into subgroups, which include, but are not necessarily limited to, derivatives of stilbene, pyrazoline, coumarin, carboxylic acid, methinecyanines, dibenzothiphene-5,5-dioxide, azoles, 5- and 6-membered-ring heterocycles, and other miscellaneous agents.

Preferred brighteners include the PHORWHITE® series of brighteners from Verona. Other brighteners disclosed in this reference include: Tinopal® UNPA, Tinopal CBS and Tinopal 5BM; available from Ciba-Geigy; Artic White® CC and Artic White CWD, available from Hilton-Davis; the 2-(4-stryl-phenyl)-2H-napthol [1,2-d]triazoles; 4,4′-bis-(1,2,3-triazol-2-yl)-stilbenes; 4,4′-bis(stryl)bisphenyls; and the aminocoumarins. Specific examples of these brighteners include 4-methyl-7-diethyl-amino coumarin; 1,2-bis(-venzimidazol-2-yl)ethylene; 1,3-diphenylphrazolines; 2,5-bis(benzoxazol-2-yl)thiophene; 2-stryl-napth-[1,2-d]oxazole; and 2-(stilbene-4-yl)-2H-naphtho-[1,2-d]triazole. Anionic brighteners are preferred herein.

The compositions may comprise e.g., derivatives of diaminostilbene disulfonic acid or alkali metal salts thereof as the optical brighteners. Suitable optical brighteners are, for example, salts of 4,4′-bis-(2-anilino-4-morpholino-1,3,5-triazinyl-6-amino)stilbene-2,2′-di-sulfonic acid or compounds of similar structure which contain a diethanolamino group, a methylamino group, an anilino group or a 2-methoxyethylamino group instead of the morpholino group. Brighteners of the substituted diphenylstyryl type may also be present, for example, the alkali metal salts of 4,4′-bis(2-sulfostyryl)diphenyl, 4,4′-bis(4-chloro-3-sulfostyryl)diphenyl or 4-(4-chlorostyryl)-4′-(2-sulfostyryl)diphenyl. Mixtures of the mentioned brighteners may also be used.

In addition, UV absorbers may also be added. These are compounds with distinct absorption abilities for ultra violet radiation, which contribute as UV stabilizers as well as to improve the light stability of colorants and pigments both for textile fibers as well as for the skin of the wearer of textile products by protecting against the UV radiation that penetrates the fabric. In general, the efficient radiationless deactivating compounds are derivatives of benzophenone, substituted with hydroxyl and/or alkoxy groups, mostly in position(s) 2 and/or 4. Also suitable are substituted benzotriazoles, additionally acrylates that are phenyl-substituted in position 3 (cinnamic acid derivatives), optionally with cyano groups in position 2, salicylates, organic Ni complexes, as well as natural substances such as umbelliferone and the endogenous urocanic acid. In a preferred embodiment, the UV absorbers absorb UV-A and UV-B radiation as well as possible UV-C radiation and re-emit light with blue wavelengths, such that they additionally have an optical brightening effect. Preferred UV absorbers encompass triazine derivatives, e.g., hydroxyaryl-1,3,5-triazine, sulfonated 1,3,5-triazine, o-hydroxyphenylbenzotriazole and 2-aryl-2H-benzotriazole as well as bis(anilinotriazinyl-amino)stilbene disulfonic acid and their derivatives. Ultra violet absorbing pigments like titanium dioxide can also be used as UV absorbers.

### 2.17 Dye Transfer Inhibiting Agents

The detergent compositions of the present invention can also include one or more materials effective for inhibiting the transfer of dyes from one fabric to another during the cleaning process. Generally, such dye transfer inhibiting agents include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from about 0.01% to about 10% by weight of the composition, preferably from about 0.01% to about 5%, and more preferably from about 0.05% to about 2%.

More specifically, the polyamine N-oxide polymers preferred for use herein are described in U.S. Pat. No. 6,491,728, incorporated herein by reference.

Any polymer backbone can be used as long as the amine oxide polymer formed is water-soluble and has dye transfer inhibiting properties. Examples of suitable polymeric backbones are polyvinyls, polyalkylenes, polyesters, polyethers, polyamide, polyimides, polyacrylates and mixtures thereof. These polymers include random or block copolymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate copolymerization or by an appropriate degree of N-oxidation. The polyamine oxides can be obtained in almost any degree of polymerization. Typically, the average molecular weight is within the range of 500 to 1,000,000; more preferred 1,000 to 500,000; most preferred 5,000 to 100,000. This preferred class of materials can be referred to as “PVNO”.

The most preferred polyamine N-oxide useful in the detergent compositions herein is poly(4-vinylpyridine-N-oxide) which as an average molecular weight of about 50,000 and an amine to amine N-oxide ratio of about 1:4.

Copolymers of N-vinylpyrrolidone and N-vinylimidazole polymers (referred to as a class as “PVPVI”) are also preferred for use herein. Preferably the PVPVI has an average molecular weight range from 5,000 to 1,000,000, more preferably from 5,000 to 200,000, and most preferably from 10,000 to 20,000. The PVPVI copolymers typically have a molar ratio of N-vinylimidazole to N-vinylpyrrolidone from 1:1 to 0.2:1, more preferably from 0.8:1 to 0.3:1, most preferably from 0.6:1 to 0.4:1. These copolymers can be either linear or branched.

The present invention compositions also can employ a polyvinylpyrrolidone (“PVP”) having an average molecular weight of from about 5,000 to about 400,000, preferably from about 5,000 to about 200,000, and more preferably from about 5,000 to about 50,000. PVP's are known to persons skilled in the detergent field. Compositions containing PVP can also contain polyethylene glycol (“PEG”) having an average molecular weight from about 500 to about 100,000, preferably from about 1,000 to about 10,000. Preferably, the ratio of PEG to PVP on a ppm basis delivered in wash solutions is from about 2:1 to about 50:1, and more preferably from about 3:1 to about 10:1.

The detergent compositions herein can also optionally contain from about 0.005% to 5% by weight of certain types of hydrophilic optical brighteners which also provide a dye transfer inhibition action. If used, the compositions herein will preferably comprise from about 0.01% to 1% by weight of such optical brighteners.

One preferred brightener is 4,4′-bis[(4-anilino-6-(N-2-bis-hydroxyethyl)-s-triazine-2-yl)amino]-2,2′-stilbenedisulfonic acid and disodium salt. This particular brightener species is commercially marketed under the trade name Tinopal-UNPA-GX® by Ciba-Geigy Corporation. Tinopal-UNPA-GX is the preferred hydrophilic optical brightener useful in the detergent compositions herein.

Another preferred brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the trade name Tinopal 5BM-GX® by Ciba-Geigy Corporation.

Another preferred brightener brightener is 4,4′-bis[(4-anilino-6-morphilino-s-triazine-2-yl)amino]2,2′-stilbenedisulfonic acid, sodium salt. This particular brightener species is commercially marketed under the trade name Tinopal AMS-GX® by Ciba Geigy Corporation.

The specific optical brightener species selected for use in the present invention provide especially effective dye transfer inhibition performance benefits when used in combination with the selected polymeric dye transfer inhibiting agents hereinbefore described. The combination of such selected polymeric materials (e.g., PVNO and/or PVPVI) with such selected optical brighteners (e.g., Tinopal UNPA-GX, Tinopal 5BM-GX and/or Tinopal AMS-GX) provides significantly better dye transfer inhibition in aqueous wash solutions than does either of these two detergent composition components when used alone. Without being bound by theory, it is believed that such brighteners work this way because they have high affinity for fabrics in the wash solution and therefore deposit relatively quick on these fabrics. The extent to which brighteners deposit on fabrics in the wash solution can be defined by a parameter called the “exhaustion coefficient”. The exhaustion coefficient is in general as the ratio of a) the brightener material deposited on fabric to b) the initial brightener concentration in the wash liquor. Brighteners with relatively high exhaustion coefficients are the most suitable for inhibiting dye transfer in the context of the present invention.

Of course, it will be appreciated that other, conventional optical brightener types of compounds can optionally be used in the present compositions to provide conventional fabric “brightness” benefits, rather than a true dye transfer inhibiting effect. Such usage is conventional and well-known to detergent formulations.

### 2.18 Thickeners

The compositions can also comprise common thickeners and anti-deposition compositions as well as viscosity regulators such as polyacrylates, polycarboxylic acids, polysaccharides and their derivatives, polyurethanes, polyvinyl pyrrolidones, castor oil derivatives, polyamine derivatives such as quaternized and/or ethoxylated hexamethylenediamines as well as any mixtures thereof. Preferred compositions have a viscosity below 10,000 mPa*s, measured with a Brookfield viscosimeter at a temperature of 20° C. and a shear rate of 50 min⁻¹.

### 2.19 Inorganic Salts

Further suitable ingredients of the composition are water-soluble inorganic salts such as bicarbonates, carbonates, amorphous silicates or mixtures of these; alkali carbonate and amorphous silicate are particularly used, principally sodium silicate with a molar ratio Na₂O:SiO₂ of 1:1 to 1:4.5, preferably of 1:2 to 1:3.5. Preferred compositions comprise alkaline salts, builders and/or cobuilders, preferably sodium carbonate, zeolite, crystalline, layered sodium silicates and/or trisodium citrate, in amounts of 0.5 to 70 wt. %, preferably 0.5 to 50 wt. %, particularly 0.5 to 30 wt. % anhydrous substance.

### 2.20 Perfumes and Colorants

The compositions can comprise further typical detergent and cleansing composition ingredients such as perfumes and/or colorants, wherein such colorants are preferred that leave no or negligible coloration on the fabrics being washed. Preferred amounts of the totality of the added colorants are below 1 wt. %, preferably below 0.1 wt. %, based on the composition. The compositions can also comprise white pigments such as e.g., TiO₂.

### 2.21 Fabric Softeners

Various through-the-wash fabric softeners, especially the impalpable smectite clays of U.S. Pat. No. 4,062,647, as well as other softener clays known in the art, can optionally be used typically at levels of from about 0.5% to about 10% by weight in the present detergent compositions to provide fabric softener benefits concurrently with fabric cleaning. Clay softeners can be used in combination with amine and cationic softeners as disclosed, for example, in U.S. Pat. No. 4,375,416, and U.S. Pat. No. 4,291,071, incorporated herein in their entirety.

### 2.22 Other Ingredients

A wide variety of other ingredients useful in detergent compositions can be included in the compositions herein, including other active ingredients, carriers, hydrotropes, processing aids, dyes or pigments, solvents for liquid formulations, solid fillers for bar compositions, etc. If high sudsing is desired, suds boosters such as the C₁₀-C₁₆ alkanolamides can be incorporated into the compositions, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous. If desired, soluble magnesium salts such as MgCl₂, MgSO₄, and the like, can be added at levels of, typically, 0.1%-2%, to provide additional suds and to enhance grease removal performance.

The detergent compositions herein will preferably be formulated such that, during use in aqueous cleaning operations, the wash water will have a pH of between about 6.5 and about 11, preferably between about 7.5 and 10.5. Laundry products are typically at pH 9-11. Techniques for controlling pH at recommended usage levels include the use of buffers, alkalis, acids, etc., and are well known to those skilled in the art.

### Antiperspirants/Deodorants

Deodorants are inventive preparations, which have antimicrobial activity and which mask, remove, or decrease perspiration odor. Antiperspirants are inventive substances, which have astringent action and inhibit the flow of perspiration.

Antiperspirants inhibit the secretion of sweat and thus remove the bacteria responsible for body odor from the breeding ground. As antiperspirants astringent metal salts are generally used, in particular inorganic and organic metal salts of the elements aluminum, zinc, magnesium, tin and zirconium as well as mixtures of these, wherein in particular halogenides such as aluminum hydroxychloride, zirconyl oxychloride and zirconyl hydroxychloride as well as mixtures of these are used. Frequently these aluminum and zirconium salts and their mixtures are also used in complex form, with propylene glycol, polyethylene glycol or glycerine being used as complexing agents.

In the following one ore more antiperspirants are preferably selected from the group selected of:

aluminium chlorohydrate; aluminium sesquichlorohydrate, aluminium chlorohydrex PG, aluminium dichlorohydrex PG, aluminium sesquichlorohydrex PG, aluminium chlorohydrex PEG, aluminium dichlorohydrex PEG, aluminium sesquichlorohydrex PEG, aluminium chloride (preferably in the form of a 15% by weight (aqueous) solution), aluminium zirconium chlorohydrate, aluminium zirconium trichlorohydrate, aluminium zirconium tetrachlorohydrate, aluminium zirconium pentachlorohydrate, aluminium zirconium octachlorohydrate, aluminium zirconium trichlorohydrex-gly, aluminium zirconium tetrachlorohydrex-gly, aluminium zirconium pentachlorohydrex-gly, aluminium zirconium octachlorohydrex-gly, buffered aluminium sulphate, basic aluminium chloride, zirconium hydroxychloride, zirconium chloride, basic aluminium nitrate, basic aluminium chloride combined with zirconyloxychloride and -hydroxychloride, organic complexes of basic aluminium chlorides and/or zirconium chloride and/or zirconium hydroxychloride.

In turn, preference here is for aluminum or aluminum zirconium complexes with a metal/anion ratio in the range 0.9:1 to 2.1:1, wherein the anion is preferably selected from the group comprising Cl⁻, Br⁻, I⁻ and/or NO₃⁻, if necessary in combination with additives such as amino acids (preferably glycine) or mono- or polyvalent alcohols. The polyvalent alcohols are preferably di-, tri- or polyols with 3-12 C-atoms, with preference here being in turn for glycerine, propylene glycol, diglycerine, tripropylene glycol, sorbitol, 1,2,4-butanetriol or 1,2,6-hexanetriol and mixtures thereof, with particular preference for glycerine and diglycerine. Advantageous monoalcohols are glycol ethers such as monoalkylether or alpha-hydroxy acids such as lactic acid.

In connection with the present invention mixtures of antiperspirants comprising (i) aluminum and/or zirconium and (ii) zinc and/or tin can be used, such as Al/Zr/Zn, Al/Zn, Al/Sn or Al/Sr/Sn, wherein mixtures comprising one or more antiperspirants from among the above-mentioned preferred aluminum- and or zirconium-based antiperspirants are in turn preferred.

If necessary the deodorants and antiperspirants according to the invention, apart from the special active ingredients described above, can contain one or more additional substances:

propellant gases, ethanol, propylene glycol, emulsifiers such as aminomethylpropanol, skin care/moisturizing agents such as 2-octyldodecanol, isopropylmyristate, isopropylpalmitate, stearamide, sorbitol, glycerine and modified polyethylene- and polypropylenglycols, vitamins and their derivatives (e.g. tocopherol (vitamin E), tocopheryl acetate (vitamin E—acetate) and ascorbic acid (vitamin C)), panthenol, allantoine, plant extracts, such as Aloe Vera and proteins, lustre agents, electrolyte salts such as KCl, NaCl, gelling substances such as hydroxyalkylcelluloses, fatty alcohols, fatty acids, fatty alcohol fatty acid esters, fatty acid glyceryl esters or similar, liquid carriers and solvents such as volatile and non-volatile silicon oils, solid carriers such as talcum, silica gels, and similar; antioxidants and preservatives, UV-light protective filters, cooling agents, additional fragrancing materials, in order to modify odor types, which increase sensory acceptance and/or improve the hedonistic feeling.

The antiperspirant/deodorant compositions of the present invention may be in the form of a solid stick, an aerosol, a pump spray, a roll-on, cream, lotion, or powder. A conventional solid stick generally comprises a wax base into which the antiperspirant salts are incorporated. Rollons and lotions are liquid based with various possible liquids serving as the vehicle. Silicones, glycols, emollients, and etc., represent some of the suitable vehicles. A number of nonessential constituents such as suspending agents, drying agents and emollients may be added to enhance cosmetic effects.

In antiperspirant creams of the present invention, the vehicle is a cream. Generally, creams contain oils and light waxes to provide the cream effect. It may also be desired to add nonessential but desirable constituents such as suspending agents, silicones, alcohol, whitening agents, and so forth. Antiperspirant powders are obviously powder based. The vehicle comprises powder constituents such as talc, kaolin, and other similar powder constituents. Other inventive anti-perspirant types include pads and gels.

### Fabric Softener Sheets

In preferred embodiments, the present invention encompasses processes for preparing articles of manufacture. These articles are adapted for use to provide unique perfume benefits and to condition (soften) fabrics in an automatic laundry dryer. Such articles are disclosed in U.S. Pat. No. 5,348,667 and the references cited therein, all of said patents being incorporated herein by reference.

The preferred fabric softener sheet of the preset invention comprises a Perfume, Perfume Particles, Fabric Conditioning Agents and a Dispensing Means.

Preferred fabric softener sheets comprise or consist of:

(A) a fabric conditioning composition comprising:
i. from about 30% to about 99% of fabric conditioning, preferably softening, agent; and
ii. an effective amount, preferably from about 0.5% to about 60%, of free perfume oil and particles according to the present invention, and
(B) a dispensing means which provides for release of an effective amount of said composition to fabrics in an automatic laundry dryer at automatic laundry dryer operating temperatures, e.g., from about 35° C. to 115° C.

When the dispensing means is a flexible substrate, e.g., in sheet configuration, the fabric conditioning composition is releasably affixed on the substrate to provide a weight ratio of conditioning composition to dry substrate ranging from about 10:1 to about 0.5:1, preferably from about 5:1 to about 1:1. The invention comprises the method of manufacturing such an article of manufacture utilizing said complex ii. by premixing the complex ii. with at least a portion of the fabric softening agent i. and mechanically working the mixture to reduce the size of the complex agglomerates to less than about 100 microns. The softener helps protect the complex from the water.

The term “fabric conditioning (softening) agent” as used herein includes cationic and nonionic fabric softeners used alone and also in combination with each other. A preferred fabric softening agent of the present invention is a mixture of cationic and nonionic fabric softeners.

### 3.1 Fabric Conditioning (Softening) Agents

Examples of fabric softening agents that are especially useful in the substrate articles are the compositions described in U.S. Pat. No. 5,348,667 and the references cited therein, all of said patents being incorporated herein by reference.

As stated hereinbefore, fabric conditioning agents can be nonionic, cationic, or mixtures thereof. These fabric conditioning agents and the compositions herein can be used for other purposes than fabric treating. E.g., the agents can be used to treat other substrates and/or for other end uses depending upon, e.g., the actives in the complex.

Examples of nonionic fabric softeners are fatty alcohols, fatty acids, fatty acid esters of, e.g., hydroxy, including polyhydroxy alcohols, including glycerine, sugars, etc., and/or fatty alcohol esters of carboxylic acids. More specific examples include sorbitan esters, C₁₂-C₂₆—fatty alcohols, and fatty amines.

More biodegradable fabric softener compounds can be desirable. Biodegradability can be increased, e.g., by incorporating easily destroyed linkages into hydrophobic groups. Such linkages include ester linkages, amide linkages, and linkages containing unsaturation and/or hydroxy groups. Examples of such fabric softeners can be found in U.S. Pat. No. 5,348,667 and the references cited therein, all of said patents being incorporated herein by reference.

A preferred fabric softener sheets of the present invention includes from about 30% to about 99%, preferably from about 40% to about 90%, of fabric conditioning (softening) agent. Preferably, said fabric softening agent is selected from cationic and nonionic fabric softeners and mixtures thereof. Preferably, said fabric softening agent comprises a mixture of about 5% to about 80% of a cationic fabric softener and about 10% to about 85% of a nonionic fabric softener by weight of said fabric treatment composition. The selection of the components is such that the resulting fabric treatment composition has a melting point above about 38° C. and is flowable at dryer operating temperatures.

### 3.2 Dispensing Means

In a preferred substrate article embodiment, the fabric treatment compositions are provided as an article of manufacture in combination with a dispensing means such as a flexible substrate which effectively releases the composition in an automatic laundry (clothes) dryer. Such dispenning means can be designed for single usage or for multiple uses. The dispensing means can also be a “carrier material” that releases the fabric softener composition and then is dispersed and/or exhausted from the dryer.

The dispensing means will normally carry an effective amount of fabric treatment composition. Such effective amount typically provides sufficient fabric conditioning agent and/or anionic polymeric soil release agent for at least one treatment of a minimum load in an automatic laundry dryer. Amounts of fabric treatment composition for multiple uses, e.g., up to about 30, can be used. Typical amounts for a single article can vary from about 0.25 g to about 100 g, preferably from about 0.5 g to about 10 g, most preferably from about 0.8 g to about 5 g.

One such article comprises a sponge material releasably enclosing enough fabric treatment composition to effectively impart fabric soil release and softness benefits during several cycles of clothes. This multi-use article can be made by filling a hollow sponge with about 20 grams of the fabric treatment composition.

Highly preferred paper, woven or nonwoven “absorbent” substrates useful herein are fully disclosed in U.S. Pat. No. 3,686,025, incorporated herein by reference. It is known that most substances are able to absorb a liquid substance to some degree; however, the term “absorbent” as used herein, is intended to mean a substance with an absorbent capacity (i.e., a parameter representing a substrate's ability to take up and retain a liquid) from 4 to 12, preferably 5 to 7, times its weight of water.

In another preferred embodiment flavored consumer products comprise one or more inventive flavor oil containing particles and are preferably products which are suitable for consumption. A product which is suitable for consumption is a product which is intended to be introduced into the human oral cavity, to remain there for a certain time and then either be swallowed, i.e. consumed (e.g. foodstuff, beverage) or removed from the oral cavity again (e.g. chewing gums and oral care compositions). This also includes substances or products which are intended to be taken in by humans or animals in the processed, partly processed or non-processed state. This furthermore includes all substances which are added to the foodstuff during its preparation, processing or working.

In a preferred embodiment inventive flavored products which are suitable for consumption are preferably selected from the group consisting of: powder products (preferably powdered beverage drink mixes, such as soft drink mixes, instant desserts in powder form, such as pudding powders), baked goods (preferably biscuits, cakes, muffins, waffles, baking mixtures), confectionery (preferably hard caramels, soft caramels, compressed products), dairy products (preferably yogurts, puddings, ice-creams), chocolate goods (preferably white, milk or plain chocolate, chocolate bars), fat compositions (preferably fillings for baked goods, such as e.g. biscuit fillings, fatty fillings for chocolate, fatty fillings for bars), chewing gums and sweets for chewing (preferably sugar-free, sugar-containing), cereals (preferably rolled oats, cornflakes), muesli mixtures (preferably conventional bulk muesli, students' mix, muesli bars, snacks and snack mixtures (preferably sweet popcorn, mixture of fruit pieces, nuts, nut bars, fruit-and-nut bars) and sprinkling mixtures (preferably toppings).

In another preferred embodiment the inventive flavored consumer products are selected from the group of dental care products, preferably dental creams, dental powders, tooth paste, tooth-cleaning foams, sugar-free candies for sucking, oral sprays, dental floss or (sugar-free) chewing gums.

Depending on the product type, the content of the inventive fragrance and/or flavor oil containing particles in an inventive consumer product is usually in the range of 0.05-10 wt. %, preferably in the range of 0.1-5 wt. %, based on the total weight of the finished perfumed and/or flavored consumer product. In a further preferred embodiment conventional base and/or auxiliary substances are additionally comprised in the inventive perfumed and/or flavored consumer products.

The preferred embodiments of the inventive consumer products can be combined in any possible way with each other and/or with the further preferred embodiments of the further subject matter of the present invention.

### EXAMPLES

The present invention is explained further with the aid of the following non-limiting examples, illustrating the parameters of and compositions employed within the present invention. Unless stated otherwise, all data, in particular percentages, parts and ratios are by weight unless otherwise indicated. Abbreviations used: DPG: dipropylene glycol, EO=ethoxylated (e.g. 11 EO=11 times ethoxylated); IPM: isopropyl myristate; PPG: polypropylene glycol.

### Materials/Instruments:

Monosodium phosphate (MSP) was obtained from Wego Chemical.

Capsul and Hi-Cap 100 were obtained from National Starch.

For determination of the average particle size a Beckman Coulter LS Particle Size Analyzer was used.

The following fragrance oils “A”, “B” and “C” were used.

TABLE I
Fragrance oil “A”: a fruity fragrance, particularly suitable for
use in detergent powder or fabric softener sheets

| Material | Parts by weight |
|---|---|
| AGRUMEX HC (2-tert.-butylcyclohexyl acetate) | 20.00 |
| ALDEHYDE C14 SO-CALLED | 9.00 |
| AMBRETTOLIDE | 0.10 |
| APHERMATE (alpha,3,3-trimethylcyclohexane- | 5.00 |
| 1-methanol formate) | |
| ETHYLENE BRASSYLATE | 20.00 |
| HEXENOL CIS-3 | 0.10 |
| HEXENYL ACETATE CIS-3 | 0.20 |
| HEXYL CINNAMIC ALDEHYDE ALPHA | 2.50 |
| ISOAMYL BUTYRATE | 1.10 |
| ISOPROPYL MYRISTATE (IPM) | 26.20 |
| LIGUSTRAL | 0.50 |
| MACROLIDE ® (15-pentadecanolide), 10% in IPM | 12.00 |
| 1:1 mixture of cis- and trans-3-methyl-γ-decalactone | 0.30 |
| PRENYL ACETATE | 3.00 |
| TOTAL | 100.00 |

TABLE II
Fragrance oil “B”: a fruity floral fragrance,
particularly suitable for use in antiperspirant

| Material | Parts by weight |
|---|---|
| ALDEHYDE C12 LAURIC, 10% in benzyl benzoate | 20.00 |
| ALDEHYDE C14 SO-CALLED | 15.00 |
| ALLYL AMYL GLYCOLATE | 40.00 |
| BENZYL ACETATE | 60.00 |
| CITRONELLOL | 60.00 |
| CYCLABUTE | 10.00 |
| DIHYDROMYRCENOL | 100.00 |
| ETHYL METHYL BUTYRATE-2 | 8.00 |
| EVERNYL | 10.00 |
| FARENAL ® | 8.00 |
| GERANYL ACETATE | 3.00 |
| GLOBALIDE ® | 100.00 |
| MUGETANOL (1-(4-isopropylcyclohexyl)ethanol) | 150.00 |
| HERBAFLORAT | 30.00 |
| HERBYL PROPIONATE | 50.00 |
| HEXENOL CIS-3 | 3.00 |
| HEXENYL ACETATE CIS-3 | 10.00 |
| IONONE BETA | 80.00 |
| ISO E SUPER ® | 201.80 |
| ISOLONGIFOLANONE | 0.10 |
| KEPHALIS | 0.10 |
| LEMON OIL TERPENES FLAVOR NATURAL | 10.00 |
| LIGUSTRAL | 6.00 |
| LINALOOL | 80.00 |
| MANZANATE (ethyl 2-methylpentanoate) | 2.00 |
| ORANGE OIL BRASIL | 23.00 |
| PRENYL ACETATE | 5.00 |
| SANDRANOL ® | 10.00 |
| VANILLIN, 10% in DPG | 5.00 |
| TOTAL | 1,100.00 |

TABLE III
Fragrance oil “C”: a powdery fragrance,
particularly suitable for use in talc preparations

| Material | Parts by weight |
|---|---|
| AGRUNITRIL | 10.00 |
| ALDEHYDE C10 | 40.00 |
| ALDEHYDE C12 MNA | 2.00 |
| ALLYL AMYL GLYCOLATE | 30.00 |
| ALLYL CYCLOHEXYL PROPIONATE | 100.00 |
| AMBROCENIDE ®, 10% in DPG | 3.00 |
| AMBROX DL | 1.00 |
| ANETHOL | 40.00 |
| BOURGEONAL | 5.00 |
| CALONE 1951 | 1.00 |
| CAMPHOR | 25.00 |
| CEDAR LEAF OIL | 25.00 |
| CEDRAMBER | 100.00 |
| CITRAL | 2.00 |
| COUMARIN | 3.00 |
| CYCLOGALBANAT ® | 20.00 |
| DAMASCONE DELTA | 1.00 |
| DIHYDRO MYRCENOL | 700.00 |
| DODECENAL TRANS-2 | 1.00 |
| EUCALYPTUS OIL GLOBULUS | 25.00 |
| EVERNYL | 10.00 |
| FARENAL ® | 50.00 |
| FLORAZON | 70.00 |
| GERANIUM OIL | 3.00 |
| GLOBALIDE ® | 30.00 |
| GLOBANONE ® | 30.00 |
| HEDIONE ® | 80.00 |
| HEXENOL CIS-3 | 5.00 |
| HEXENYL ACETATE CIS-3 | 15.00 |
| HEXYL SALICYLATE | 50.00 |
| ISO E SUPER ® | 100.00 |
| ISOBUTYL QUINOLINE | 1.00 |
| ISOEUGENOL | 1.00 |
| LIGUSTRAL | 5.00 |
| LINALOOL | 103.00 |
| MELONAL ® | 20.00 |
| PATCHOULI OIL | 1.00 |
| SANDRANOL ® | 46.00 |
| STYRALYL ACETATE | 17.00 |
| THYMOL, 10% in DPG | 4.00 |
| TIMBEROL ® | 2.00 |
| VERNALDEHYDE (1-methyl-4-isohexyl- | 3.00 |
| hexahydrobenzaldehyde) | |
| VERTOFIX | 20.00 |
| TOTAL | 1,800.00 |

The following flavor oils “D” and “E” were used.

Flavor oil “D”: a 1:1 mixture of natural lemon and grapefruit essentail oils.

TABLE IV
Flavor oil “E”: (synthetic peppermint oil)

| Material | Parts by weight |
|---|---|
| Isobutyraldehyde | 0.5 |
| 3-Octanol | 0.5 |
| Dimethyl sulfide | 0.5 |
| trans-2-Hexenal | 1.0 |
| cis-3-Hexenol | 1.0 |
| 4-Terpineol, natural | 1.0 |
| Isopulegol | 1.0 |
| Piperitone, natural, from eucalyptus | 2.0 |
| Linalool | 3.0 |
| 8-Ocimenyl acetate, 10 wt. % in triacetin | 5.0 |
| Isoamyl alcohol | 10.0 |
| Isovaleraldehyde | 10.0 |
| alpha-Pinene | 25.0 |
| beta-Pinene, natural | 25.0 |
| Neomenthol, racemic | 40.0 |
| Eucalyptol (1,8-cineol), natural | 50.0 |
| L-Menthyl acetate | 70.0 |
| L-Menthone | 220.0 |
| D-Isomenthone | 50.0 |
| L-Menthol | 484.5 |
| TOTAL | 1,000.00 |

### Example 1

### All Spray-Dried Particles

The Process of spray-drying was performed at the following conditions: A spray dryer such as Anhydro #1 lab dryer equipped with a rotary atomizer or two fluid nozzle or high pressure nozzle. Drying conditions were: inlet at 190° C. and outlet at 90° C., each plus or minus 5° C. Process equipment can encompass any spray-dryer that can emulate these conditions. The results are encompassed in Table 1.

TABLE 1
Mixtures before drying and results after spray drying*

| | | | | | | | |
|---|---|---|---|---|---|---|---|
| Examples | 1A | 1B | 1C | 1D | 1E | 1F | 1G |

Mixtures before drying

| | | | | | | | |
|---|---|---|---|---|---|---|---|
| Type fragrance oil | A | B | B | C | D | E | A |
| Amount fragrance | 42.0 | 30.0 | 42.0 | 45.0 | 43.0 | 41.0 | 47.3 |
| oil | | | | | | | |
| Modified starch | 9.36 | 10.0 | 11.7 | 9.75 | 9.75 | 11.5 | 7.8 |
| MSP | 2.34 | 10.0 | 6.3 | 5.25 | 5.25 | 6.4 | 4.7 |
| Mannitol | 2.34 | — | — | — | — | — | — |
| Wate rat 40° C. | 40.0 | 50.0 | 40.0 | 40.0 | 40.0 | 40.0 | 40.0 |

Results after spray-drying

| | | | | | | | |
|---|---|---|---|---|---|---|---|
| Total fragrance oil | 65.43 | 59.95 | 68.79 | 74.06 | 68.1 | 66.92 | 76.26 |
| Surface fragrance | 2.32 | 0.57 | 1.42 | 2.95 | 2.3 | 1.52 | 3.97 |
| oil | | | | | | | |
| Residula water | 0.83 | 1.28 | 0.97 | 1.98 | 1.28 | 0.91 | 0.31 |
| Average particle | n.d. | n.d. | 19.2 μm | n.d. | n.d. | n.d. | n.d. |
| size | | | | | | | |

*% = to wt.-% based on the mixture before drying or the results after spray-drying

### Example 2

### Formulation Examples

In the following the invention is explained in more detail by various formulation examples.

TABLE V
Free perfume oil P1

| | Parts |
|---|---|
| Components | by weight |
| 10-undecenal, 10% in DPG | 2.00 |
| Vertocitral (2,4-dimethyl-3-cyclohexencarboxaldehyde) | 0.50 |
| cis-3-Hexenyl acetate, 10% in DPG | 7.50 |
| Allylamylglycolate | 2.00 |
| Melonal (2,6-dimethyl-5-hepten-1-al) | 0.50 |
| Bergamot oil | 70.00 |
| Dihydromyrcenol | 80.00 |
| Cyclogalbanate (allylcyclohexyloxy acetate) | 20.00 |
| Terpinyl acetate | 40.00 |
| Litsea cubeba oil | 2.00 |
| Lemon oil | 50.00 |
| Orange oil | 20.00 |
| Grapefruit oil | 10.00 |
| Lavandin oil abrialis | 10.00 |
| Isobornyl acetate | 3.00 |
| Lilial (2-methyl-3-(4-tert-butyl-phenyl)propanal) | 10.00 |
| Calone ® 1951 (7-methyl-2H-1,5-benzodioxepin-3(4H)-one) | 2.50 |
| Florhydral ® (3-(3-isopropylphenyl)butanal) | 1.50 |
| Florol ® (2-isobutyl-4-methyltetrahydro-2H-pyran-4-ol) | 12.00 |
| Tetrahydrolinalool | 75.00 |
| Geranium oil | 5.00 |
| Isodamascon (1-(2,4,4-trimethyl-2-cyclohexen-1-yl)- | 2.00 |
| 2-buten-1-one), 10% inDPG | |
| Resedafol, 10% in DPG [2-(1-propoxyethoxy)ethyl]benzol | 1.00 |
| Methyl dihydrojasmonate (Hedione ® HC) | 158.00 |
| L-menthylmethylether | 50.00 |
| Jessemal (3-butyl-5-methyl tetrahydropyran-4-yl-acetate) | 4.00 |
| Benzyl salicylate | 10.00 |
| Anethol | 3.00 |
| Methylcedrylketone | 50.00 |
| Iso E Super ®⁺⁺ | 25.00 |
| Ambrocenide ® ((4aR,5R,7aS,9R)-octahydro- | 3.00 |
| 2,2,5,8,8,9a-hexamethyl-4H-4a,9- | |
| methanoazuleno(5,6-d)-1,3-dioxol), 1% in DPG | |
| Timberol (1-(2,2,6-trimethylcyclohexyl)hexan-3-ol) | 2.00 |
| Patchouli oil | 3.50 |
| Evernyl ® (methyl-2,4-dihydroxy-3,6-dimethylbenzoate) | 1.50 |
| Labdanum absolute, 20% in DPG | 2.00 |
| Amber Core (1-[[2-(1,1-dimethylethyl)cyclohexyl]oxy]- | 10.00 |
| 2-butanol) | |
| Ambraketal (dodecahydro-3,8,8,11a-tetramethyl-5H-3,5a- | 1.50 |
| epoxynaphth[2,1-c]oxepin) | |
| Hydroxyambran ® (2-cyclododecylpropanol), 50% in DPG | 5.00 |
| Macrolide ® (15-cyclopentadecanolide) | 35.00 |
| Globalide ® (15-pentadec-(11/12)-enolide) | 20.00 |
| Globanone ® ((E/Z)-8-cyclohexadecenone) | 20.00 |
| Isopropylmyristate | 170.00 |
| TOTAL | 1,000.00 |

⁺⁺Octahydro-2,3,8,8-tetramethyl-2-acetonaphthone and 2-acetyl-1,2,3,4,6,7,8-octahydro-2,3,8,8-tetramethylnaphthaline

TABLE VI
Free perfume oil with rose odor P2

| Components | Parts by weight |
|---|---|
| Acetophenone, 10% in DPG | 10.00 |
| n-Undecanal | 5.00 |
| Aldehyde C14 so-called (peach aldehyde) | 15.00 |
| Allylamylglycolate, 10% in DPG | 20.00 |
| Amylsalicylate | 25.00 |
| Benzyl acetate | 60.00 |
| Citronellol | 80.00 |
| d-Limonen | 50.00 |
| Trans-9 decenol | 15.00 |
| Dihydromyrcenol | 50.00 |
| Dimethylbenzyl carbinyl acetate | 30.00 |
| Diphenyl oxide | 5.00 |
| Eucalyptus oil | 10.00 |
| Geraniol | 40.00 |
| Nerol | 20.00 |
| Geranium oil | 15.00 |
| Hexenol cis-3, 10% in DPG | 5.00 |
| Hexenyl salicylate cis-3 | 20.00 |
| Indol, 10% in DPG | 10.00 |
| Alpha-Ionone | 15.00 |
| Beta-Ionone | 5.00 |
| Lilial (2-methyl-3-(4-tert-butyl- | 60.00 |
| phenyl)propanal) | |
| Linalool | 40.00 |
| Methylphenyl acetate | 10.00 |
| Phenylethyl alcohol | 275.00 |
| Styrene acetate | 20.00 |
| Terpineol | 30.00 |
| Tetrahydrolinalool | 50.00 |
| Cinnamon alcohol | 10.00 |
| TOTAL | 1,000.00 |

TABLE VII
Free perfume oil with woody musk odor P3

| Components | Parts by weight |
|---|---|
| Ambrettolide | 5.00 |
| p-tert-Butyl cyclohexyl acetate | 10.00 |
| Cedrol | 10.00 |
| Exaltolide | 5.00 |
| Galaxolide, 50% in IPM | 15.00 |
| Hexadecanolide | 1.00 |
| Gamma-n-methyl ionone | 10.00 |
| Iso E Super | 8.00 |
| Musk indanone | 7.00 |
| Musk tibetine | 5.00 |
| Patchouli alcohol | 7.00 |
| Vetiveryl acetate | 5.00 |
| Methyl dihydrojasmonate | 8.00 |
| Coumarin | 3.00 |

TABLE 2
Talc powder

| Ingredient | Supplier | % Wt |
|---|---|---|
| Ultra Talc 3000 | Ultra Products | 98.50 |
| Free perfume oil | Symrise | 0.50 |
| Particles of Example 1d | | 1.00 |

Compounding Procedure: mix talc thoroughly with free perfume oil and Particles according to the present invention.

TABLE 3
Antiperspirant stick

| Ingredient | Supplier | % Wt |
|---|---|---|
| Gelling Agent GP-1 (Dibutyl Lauroyl Glutamide) | Ajinonoto | 2.00 |
| Casid HSA (Hydroxystearic Acid) | CasChem | 6.00 |
| DC 244 Fluid (Cyclomethicone) | Dow Corning | 48.05 |
| Eutanol G (Octyldodecanol) | BASF | 13.9 |
| Performathox 450 (C20-40 Pareth-10) | New Phase | 1.25 |
| | Technologies | |
| Performathox 480(C20-40 Pareth 40) | New Phase | 1.25 |
| | Technologies | |
| Performacol 425(C20-40 Alcohols) | New Phase | 0.50 |
| | Technologies | |
| Versene NA (Disodium EDTA) | Dow Chemical | 0.05 |
| Reach AZP-908 SUF(Aluminum Zirconium | Reheis | 25.0 |
| Tetrachlorohydrex Gly) | | |
| Free perfume oil 1-P1 | | 0.75 |
| Particles of Example 1b | | 1.25 |

Compounding Procedure: add the ingredient parts 1-7 to a suitable vessel and heat to 80° C. Mix until all waxes are melted and clear homogeneous solution is achieved. Allow to cool to 70° C. with continued mixing. Add ingredients 8 and 9 with mixing until fully dispersed. Continue to mix while cooling to 65° C. Add ingredients 10 and 11, and mix and pour into stick containers.

TABLE 4
Antiperspirant aerosol

| Ingredient | Supplier | wt. % |
|---|---|---|
| DC Fluid 244 (Cyclomethicone) | Dow Corning | 10.00 |
| Micro Dry (Aluminum Chlorohydrate) | Reheis | 7.50 |
| Myritol PC (Propylene Glycol | BASF | 1.25 |
| Dicaprylate/Dicaprate) | | |
| Free perfume oil of Example 1-P2 | | 0.75 |
| Particles of Example 1c | | 0.50 |
| Hydrocarbon Propellant A-46 | | 80.0 |

Compounding Procedure: combine parts 1-5 in a suitable vessel. Mix until a homogeneous dispersion is achieved. Fill into aerosol cans, crimp on valve and pressure fill propellant (part 6) (a 20/80 blend of propane/isobutane).

TABLE 5
Fabric Softener Sheet

| Ingredient | Supplier | wt. % |
|---|---|---|
| Varisoft DS-150 | Evonik | 97.00 |
| Free perfume oil | Symrise | 1.50 |
| Particles of Example 1a | | 1.50 |

Compounding Procedure: Melt Quat (part 1), add Free perfume oil and Particles of Example 1a. Using a spatula spread 1.1 g of the mixture onto a 6×9 inches non-woven sheet.

TABLE 6
Non-phosphate powdered detergent

| Ingredient | Supplier | wt. % |
|---|---|---|
| Tomadol 25-7 (Peg-7 Pareth 12-15 | Tomah Products | 6.00 |
| Tomadol 25-3 (Peg-3 Pareth 12-15) | Tomah Products | 2.00 |
| Sodium metasilicate, pentahydrate | | 57.55 |
| Sodium Carbonate | | 33.00 |
| Carboxymethylcellulose | | 1.00 |
| Free perfume oil of Example 1-P3 | Symrise | 0.15 |
| Particles of Example 1g | | 0.30 |

TABLE 7
Antiperspirant sticks (% by weight)

| Ingredient | A | B |
|---|---|---|
| Phenyl Trimethicon (SilCare TM Silicone 15 M 50) | 13.50 | 13.50 |
| Cetearyl alcohol | To 100 | To 100 |
| Cetiol CC (dicaprylyl carbonate) | 13.50 | 13.50 |
| Stearic acid | 3.50 | 3.50 |
| PEG-40-hydrated castor oil (Emulsogen TM HCO | 4.10 | 4.10 |
| 040) | | |
| PEG-8 distearate (Cithrol 4 DS) | 4.10 | 4.10 |
| Petrolatum | 6.90 | 6.90 |
| Aluminum hydrochlorate | 13.80 | 13.80 |
| Aluminum zirconium trichlorohydrex gly | 20.00 | 19.50 |
| Neo Heliopan ® Hydro (phenylbenzimidazole | 2.00 | 0.50 |
| sulphonic acid) | | |
| 2,2-dimethyl-3-phenylpropanol | — | 0.25 |
| Ethylhexylglycerine (octoxyglycerin) | — | 0.30 |
| 1,1-dimethyl-3-phenylpropanol | — | 0.25 |
| Particles according to Example 1c | 0.50 | — |
| Perfume oil according to Example 1-P1 | 0.55 | — |
| Particles according to Example 1d | — | 0.30 |
| Perfume oil according to Example 1-P2 | — | 1.00 |

TABLE 8
Suspension roll-on (% by weight)

| Ingredient | A | B |
|---|---|---|
| Silicone | To 100 | To 100 |
| Ethylhexylglycerine (octoxyglycerin) | 1.00 | 1.00 |
| Quaternium-18 hectorite | 13.00 | 13.20 |
| Aluminum hydrochlorate, powder | 21.00 | 20.00 |
| 1,1-dimethyl-3-phenylpropanol | 0.25 | 0.50 |
| 4-methyl-4-phenyl-2-pentanol | 0.10 | — |
| Particles according to Example 1c | 0.25 | — |
| Perfume oil according to Example 1-P2 | 1.00 | — |
| Particles according to Example 1b | — | 0.25 |
| Perfume oil according to Example 1-P1 | — | 0.85 |

TABLE 9
Suspension stick (% by weight)

| Ingredient | A | B |
|---|---|---|
| Stearyl alcohol | 20.00 | 20.00 |
| Cyclomethicone | To 100 | To 100 |
| PPG-14 butyl ether | 2.00 | 2.00 |
| Hydrated castor oil | 1.00 | 1.00 |
| Talc | 2.00 | 2.00 |
| Aluminum hydrochlorate, powder | 20.00 | 20.00 |
| Triclosan ® (5-chloro-2-(2,4-dichlorphenoxy)phenol) | 0.30 | — |
| Ethylhexylglycerine (octoxyglycerin) | 0.50 | 0.80 |
| 1,1-dimethyl-3-phenylpropanol | 0.30 | 0.40 |
| 2,2-dimethyl-3-phenylpropanol | 0.30 | 0.15 |
| Anis alcohol | 0.10 | — |
| Particles according to Example 1b | 0.50 | — |
| Perfume oil according to Example 1-P1 | 0.55 | — |
| Particles according to Example 1g | — | 0.30 |
| Perfume oil according to Example 1-P2 | — | 0.80 |

TABLE 10
Heavy duty granular detergent (% by weight)

| Ingredient | A | B |
|---|---|---|
| C₁₂ Linear alkylbenzene sulfonate (Na) | 9.00 | 9.00 |
| C₁₄₋₁₅ Alkyl ethoxy/EO = 0.6) sulfate (Na) | 1.60 | 1.60 |
| C₁₂₋₁₈ Alkyl sulfate | 5.70 | 5.70 |
| Polyacrylate (MW = 4500) | 3.20 | 3.20 |
| Aluminosilicate | 26.30 | 26.30 |
| Sodium silicate | 0.60 | 0.60 |
| Sodium carbonate | 27.90 | 27.90 |
| Sodium sulfate | 8.90 | 8.90 |
| Optical Brightener | 0.20 | 0.20 |
| Perborate | 1.00 | 1.00 |
| Cellulase (5 CEVU/g) CAREZYME ® | 0.60 | 0.60 |
| Protease (0.0062 AU/g) according to U.S. | 0.30 | 0.30 |
| Pat. No. 5,185,258 | | |
| Lipase (206 LUI/g) LIPOLASE ® | 0.20 | 0.20 |
| Nonionic | 3.00 | 3.00 |
| Particles according to Example 1g | 0.25 | — |
| Perfume oil according to Example 1-P3 | 0.30 | — |
| Particles according to Example 1a | — | 0.20 |
| Perfume oil according to Example 1-P3 | — | 0.35 |
| Miscellaneous (water and other minors) | To 100 | To 100 |

TABLE 11
Heavy duty liquid detergent (% by weight)

| Ingredient | A | B |
|---|---|---|
| C₁₄₋₁₅ Alkyl polyethoxylate (2.25) sulfonic acid | 23.00 | 12.50 |
| C₁₂₋₁₃ Linear alkyl benzene sulfonic acid | — | 11.46 |
| 1,2 Propanediol | 10.50 | 10.50 |
| Monoethanolamine | 12.50 | 12.50 |
| C₁₂₋₁₃ Alkyl polyethoxylate (6.5) | 6.00 | 6.00 |
| Ethanol | 3.80 | 3.80 |
| Polyhydroxy C₁₂₋₁₄ fatty acid amide | 9.00 | 9.00 |
| C₁₂₋₁₄ Coconut fatty acid | 9.00 | 9.00 |
| Citric acid | 6.00 | 6.00 |
| DTPA (Diethylenetriaminepentaethylene phosphonic | 0.95 | 0.95 |
| acid) | | |
| Sodium formate | 0.14 | 0.14 |
| Boric acid | 2.40 | 2.40 |
| Tetraethylenepentaamine ethoxylate (15-18) | 1.00 | 1.00 |
| Soil release polymer | 0.46 | 0.46 |
| Enzymes (protease, lipase, cellulase) | 2.55 | 2.55 |
| Silicone antifoam composition | 0.04 | 0.04 |
| Poly(4-vinylpyridine)-N-oxide (PVNO) | 0.10 | 0.10 |
| Brightener - Tinopal UNPA-GX | 0.20 | 0.20 |
| Particles according to Example 1a | 0.15 | — |
| Perfume oil according to Example 1-P2 | 0.10 | — |
| Particles according to Example 1c | — | 0.10 |
| Perfume oil according to Example 1-P3 | — | 0.15 |
| Miscellaneous (water and other minors) | To 100 | To 100 |

TABLE 12
Compact granular detergent compositions (% by weight)

| Ingredient | A | B |
|---|---|---|
| C₁₁₋₁₄ Linear alkylbenzene sulfonate (Na) | 11.40 | — |
| C₁₂₋₁₄ N-methyl glucamide | — | 13.00 |
| Tallow alkyl sulfate | 1.80 | 1.80 |
| C₄₅ Alkyl sulfate | 3.00 | 3.00 |
| C₄₅ Alcohol (7 EO) | 4.00 | 4.00 |
| Tallow alcohol (11 EO) | 1.80 | 1.80 |
| Dispersant | 0.07 | 0.07 |
| Silicone fluid | 0.80 | 0.80 |
| Trisodium citrate | 14.00 | 14.00 |
| Citric acid | 3.00 | 3.00 |
| Zeolites (incl. Zeolite A and Zeolite X) | 32.50 | 32.50 |
| Maleic acid - acrylic acid copolymer | 5.00 | 5.00 |
| Cellulase (active protein) | 0.04 | 0.04 |
| Alkalase | 0.60 | 0.60 |
| Lipase | 0.36 | 0.36 |
| Sodium silicate | 2.00 | 2.00 |
| Sodium sulfate | 3.50 | 3.50 |
| Poly(4-vinylpyridine)-N-oxide (PVNO) | 0.10 | — |
| N-vinylpyrrolidone/N-vinylimidazole copolymer - MW | — | 0.20 |
| 10,000 (PVPVI) | | |
| Brightener - Tinopal UNPA-GX | 0.20 | — |
| Brightener - Tinopal 5BM-GX | — | 0.20 |
| Particles according to Example 1a | 0.25 | — |
| Perfume oil according to Example 1-P3 | 0.30 | — |
| Particles according to Example 1c | — | 0.25 |
| Perfume oil according to Example 1-P1 | — | 0.25 |
| Miscellaneous (water and other minors) | To 100 | To 100 |

### Example 3

### Sugar Reduced Beverage Mixture

A dry mixture comprising the ingredients of the following table was prepared; % refers to wt.-% based on the dry mixture.

TABLE 13
Sugar-reduced instant beverage mix

| Ingredient | Parts b.w. |
|---|---|
| sugar (sucrose) | 82.169 |
| citric acid | 11.58 |
| trisodium citrate | 0.70 |
| tricalcium phosphate | 0.60 |
| ascorbic acid (vitamin C) | 0.66 |
| Grindsted JU 543 stabilizer system | 0.90 |
| Na-saccharin | 0.561 |
| spray-dried orange flavor, including yellow colorant tartrazine | 1.33 |
| Particles of Example 1e | 1.50 |

### Example 4

### Chewing Gum Composition

TABLE 14
Chewing gum with particles according to the invention;
% refers to wt.-% based on the chewing gum.

| Ingredient | Parts b.w. |
|---|---|
| sorbitol | 40.0 |
| gum base | 32.0 |
| calcium carbonate | 15.0 |
| glycerin | 1.5 |
| mannitol | 4.5 |
| sorbitol liquid | 3.0 |
| liquid peppermint flavor | 0.5 |
| encapsulated menthol | 1.0 |
| encapsulated aspartame | 0.5 |
| particles of Example 1f | 1.0 |

### Example 5

Chewing gum base K2 comprised 28.5% terpene resin, 33.9% polyvinyl acetate (MW=14,000), 16.25% hydrogenated plant oil, 5.5% mono- and diglycerides, 0.5% polyisobutene (MW 75,000), 2.0% butyl rubber (isobutene/isoprene copolymer), 4.6% amorphous silicon dioxide (water content approx. 2.5%), 0.05% antioxidant tert-butylhydroxytoluene (BHT), 0.2% lecithin, and 8.5% calcium carbonate. Chewing gum base K2 and the chewing gums can be prepared analogously to U.S. Pat. No. 6,986,907, incorporated herein in its entirety.

TABLE 15
Chewing gum with particles according
to the invention (% by weight)

| Ingredient | A | B |
|---|---|---|
| Chewing gum base K2 | 25.30 | 26.30 |
| Sorbitol | Ad 100 | Ad 100 |
| Glycerol | 2.40 | 2.40 |
| Lecithin | 7.00 | 7.00 |
| Aspartame | 0.14 | 0.14 |
| Encapsulated aspartame | 0.68 | 0.68 |
| Menthol, spray-dried | 0.25 | 0.50 |
| Lemon aroma, spray-dried | — | — |
| Particles of Example 1f | 1.25 | 0.95 |

The chewing gums of recipe (I) were shaped as strips, and those of recipe (II) were shaped as pellets.

### Example 6

Chewing gum base K1 comprised 2.0% butyl rubber (isobutene/isoprene copolymer, MW 400,000), 6.0% polyisobutene (MW=43,800), 43.5% polyvinyl acetate (MW 12,000), 31.5% polyvinyl acetate (MW=47,000), 6.75% triacetin and 10.25% calcium carbonate. Chewing gum base K1 and the chewing gums (I) and (II) can be prepared analogously to U.S. Pat. No. 5,601,858, incorporated herein in its entirety.

TABLE 16
Non-stick chewing gum with particles according
to the invention (% by weight)

| Ingredient | A | B |
|---|---|---|
| Chewing gum base K1 | 26.00 | 26.00 |
| Triacetin | 0.25 | 0.25 |
| Lecithin | 0.50 | 0.50 |
| Sorbitol, crystalline | Ad 100 | Ad 100 |
| Mannitol | 15.30 | 15.20 |
| Glycerol | 12.10 | 12.00 |
| Aspartame | 0.17 | 0.17 |
| Encapsulated aspartame | 1.08 | 1.08 |
| Amorphous silica | 1.00 | 1.00 |
| Cottonseed oil | 0.50 | 0.50 |
| Polyoxyethylene sorbitan monolaurate (E-432) | 1.00 | 1.00 |
| Menthone glycerine acetal (Frescolat ® MGA) | — | 0.15 |
| Encapsulated spearmint flavor (contains l-carvone) | 0.20 | 0.10 |
| Encapsulated wintergreen flavor (contains methyl | — | 0.10 |
| salicylate) | | |
| Particles of Example 1f | 1.40 | 1.00 |

The chewing gums of recipe (I) were shaped as strips, and those of recipe (II) were shaped as pellets.

Having thus described the invention in detail, it will be clear to those skilled in the art that various changes may be made without departing from the scope of the invention and the invention is not to be considered limited to what is described in the specification.

1. A particle containing a fragrance and/or flavour oil, the particle comprising:
(a) 50 to 80 wt. % fragrance and/or flavour oil,
(b) 5 to 25 wt. % octenylsuccinated starch,
(c) 5 to 25 wt. % of one or more mono alkaline metal phosphate salts,
(d) 0 to 10 wt. % of one or more additional ingredients,
on condition that the amounts add to 100 wt. % and wherein the weight percent values are based on the total dry weight of the particle.

2. The particle according to claim 1 comprising:
(a) 55 to 78 wt. % fragrance and/or flavour oil, and/or
(b) 10 to 25 wt. % octenylsuccinated starch, and/or
(c) 5 to 15 wt. % of monosodium and/or monopotassium phosphate and/or
(d) 0 to 5 wt. % of one or more additional ingredients,
on condition that the amounts add to 100% b.w. and wherein the weight percent values are based on the total dry weight of the particle.

3. The particle according to claim 2 comprising:
(a) 60 to 75 wt. % fragrance or flavour oil,
(b) 15 to 22 wt. % of octenylsuccinated starch,
(c) 8 to 12 wt. % of monosodium phosphate and
(d) 0 to 5 wt. % additional ingredients
on condition that the amounts add to 100% b.w. and wherein the weight percent values are based on the total dry weight of the particle.

4. The particle according to claim 1 having:
(i) a particle size equal to or less than 300 microns, and/or
(ii) a residual water content equal to or less than 3 wt. %, and/or
(iii) an amount of surface oil of equal to or less than 4 wt. %,
wherein all weight percent values are based on the total dry weight of the particles.

5. The particle according to claim 4 having:
(i) an average particle size in the range of 5 to 125 microns, and/or
(ii) a residual water content in the range of 0.1 to 2.5 wt. %, and/or
(iii) an amount of surface oil of less than 3 wt. %,
wherein all weight percent values are based on the total dry weight of the particles.

6. A process for producing the particles according to claim 1 comprising the steps:
(i) forming a mixture comprising the following constituents (a) through (e)
(a) 20 to 56 wt. % fragrance and/or flavour oil,
(b) 2 to 17.5 wt. % octenylsuccinated starch,
(c) 2 to 17.5 wt. % of one or more mono alkaline metal phosphate salts,
(d) 0 to 7 wt. % of one or more additional ingredients and
(e) 30 to 60 wt. % of water,
on condition that the amounts add to 100% b.w. and wherein the weight percent values are based on the total weight of the mixture and then
(ii) drying the mixture of step i) to produce the fragrance and/or flavour oil containing particles.

7. The process for producing the particles according to claim 6, wherein one or more of the following amounts of constituents (a) through (e) are provided in step i):
(a) 27.5 to 52 wt. % fragrance and/or flavour oil and/or
(b) 2.25 to 11.25 wt. % octenylsuccinated starch and/or
(c) 2.25 to 11.25 wt. % of one or more mono alkaline metal phosphate salts, and/or
(d) 0 to 6.5 wt. % of one or more additional ingredients, and/or
(e) 35 to 55 wt. % of water,
on condition that the amounts add to 100% b.w. and wherein the weight percent values are based on the total weight of the mixture.

8. The process for producing the particles according to claim 6, wherein the drying step ii) is a spray-drying step.

9. A particle containing fragrance and/or flavour obtainable by the process according to claim 6.

10. A perfumed and/or flavoured consumer product comprising one or more particles containing fragrance and/or flavour oil according to claim 1.

11. A method of perfuming or flavouring a consumer product by adding one or more particles containing fragrance and/or flavour oil according to claim 1 to the consumer product.

12. A method for perfuming and/or flavouring a consumer product comprising adding one or more of the particles containing fragrance and/or flavour oil according to claim 1 to a consumer product.
